(19) United States
(12) Patent Application Publication
(10) Pub. No.: US 2025/0165620 A1
(43) Pub. Date: May 22, 2025

(54) METHOD AND APPARATUS FOR DETECTING SECURITY VULNERABILITY OF DYNAMIC MEMORY

(71) Applicant: ELECTRONICS AND TELECOMMUNICATIONS RESEARCH INSTITUTE, Daejeon (KR)

(72) Inventors: HONG-IL JU, Daejeon (KR); Dong-Wook KANG, Daejeon (KR); GAE-IL AN, Daejeon (KR)

(73) Assignee: ELECTRONICS AND TELECOMMUNICATIONS RESEARCH INSTITUTE, Daejeon (KR)

(21) Appl. No.: 18/923,303

(22) Filed: Oct. 22, 2024

(30) Foreign Application Priority Data
Nov. 20, 2023 (KR) 10-2023-0160608
May 31, 2024 (KR) 10-2024-0071219

(51) Int. Cl. G06F 21/57

(52) U.S. Cl. CPC G06F 21/577; G06F 2221/034

(57) ABSTRACT

Disclosed herein is a method for detecting a security vulnerability of dynamic memory. The method includes allocating a heap area in physical memory in response to a heap allocation request from a user, allocating a heap area of virtual memory corresponding to the heap area in the physical memory, and returning a heap allocation address to the user, and the heap allocation address includes heap authentication information, heap allocation address identification information, and heap size information.

### CROSS REFERENCE TO RELATED APPLICATIONS

This application claims the benefit of Korean Patent Applications No. 10-2023-0160608, filed Nov. 20, 2023, and No. 10-2024-0071219, filed May 31, 2024, which are hereby incorporated by reference in their entireties into this application.

### BACKGROUND OF THE INVENTION

### 1. Technical Field

The present disclosure relates to dynamic memory management technology for dynamically allocating a memory area and deallocating the allocated memory area.

More particularly, the present disclosure relates to dynamic memory management technology capable of efficiently detecting dynamic memory security vulnerabilities, such as Use-After-Free (UAF), Double Free Bug (DFB), and Heap-based Buffer OverFlow (HBoF), while enhancing security.

### 2. Description of the Related Art

Use-After-Free (UAF) is a common vulnerability that occurs when dynamically allocated memory can be accessed even after deallocation thereof, and attacks exploiting it have continued to occur until recently. Also, vulnerabilities such as Double Free Bug (DFB), which attempts to again deallocate a deallocated dynamic memory area, and Heap-based Buffer OverFlow (HBOF), which is caused when the range of an allocated memory area is overflowed, also occur.

Many studies are underway to solve security vulnerabilities that occur when dynamic memory is used, but it is necessary to efficiently solve security vulnerabilities while minimizing performance overhead or memory overhead.

### DOCUMENTS OF RELATED ART

(Patent Document 1) Korean Patent No. 1890125, titled “Memory alignment randomization method for mitigation of heap exploit”.

### SUMMARY OF THE INVENTION

An object of the present disclosure is to effectively detect a Use-After-Free (UAF) vulnerability in dynamic memory allocation.

Another object of the present disclosure is to effectively detect Double Free Bug (DFB) that occurs when a deallocated heap area is deallocated again.

In order to accomplish the above objects, a method for detecting a security vulnerability of dynamic memory according to an embodiment of the present disclosure includes allocating a heap area in physical memory in response to a heap allocation request from a user, allocating a heap area of virtual memory corresponding to the heap area in the physical memory, and returning a heap allocation address to the user, and the heap allocation address includes heap authentication information, heap allocation address identification information, and heap size information.

Here, the heap area may include a heap header area and a heap body area.

Here, the heap allocation address may include the start address of the heap body area allocated in the physical memory.

Here, the heap authentication information may include most significant 7 bits and least significant 7 bits of a hash value generated based on previous heap authentication information, the heap size information, and a heap-allocation virtual address.

Here, the heap header area of the virtual memory may indicate previous heap authentication information and access permission information, the heap body area of the virtual memory may indicate the heap size information and access permission information, and the heap size information in the heap body area may correspond to a heap offset (heap_offset) value defined in 16-byte increments.

Here, the heap size information may correspond to 1-bit information that indicates 1 when the size of the allocated heap area is greater than a preset size and that indicates 0 when the size of the allocated heap area is equal to or less than the preset size.

Here, when access to the heap area in the physical memory occurs, access permission information in the virtual memory corresponding to the physical memory may be checked, and the access may be blocked based on the access permission information.

Here, when access to the heap area in the physical memory occurs, the address of the header area of the virtual memory may be calculated using heap size information in the virtual memory, and when the heap size information is 7 bits (b7˜b1) at the calculated address and corresponds to ‘0000000’, it may be determined that the address is not the header area of the virtual memory, and the address of the header area of the virtual memory may be calculated again based on a multiple of ‘0x80’.

Here, the method may further include setting heap deallocation information in response to a heap deallocation request from the user, and setting the heap deallocation information may comprise filling the first 8 bytes of the heap body area of the physical memory corresponding to the heap deallocation request with a forward deallocated heap address, filling the second 8 bytes of the heap body area of the physical memory corresponding to the heap deallocation request with a backward deallocated heap address, and initializing the remaining heap body area to 0.

Here, setting the heap deallocation information may comprise updating the header area of the virtual memory corresponding to the heap deallocation request with previous heap authentication information and changing access permission information in the body area of the virtual memory corresponding to the heap deallocation request to 0.

Here, the method may further include, after heap deallocation, reallocating a heap area in response to a heap reallocation request from the user, and reallocating the heap area may include reallocating the heap area in the physical memory, updating heap area reallocation information in virtual memory corresponding to the reallocated physical memory, and returning a heap reallocation address to the user.

Here, updating the heap area reallocation information in the virtual memory may comprise maintaining previous heap authentication information in the heap header area of the virtual memory and updating the heap body area of the virtual memory.

Also, in order to accomplish the above objects, an apparatus for detecting a security vulnerability of dynamic memory according to an embodiment of the present disclosure includes a physical memory management unit for allocating a heap area in physical memory in response to a heap allocation request from a user, a virtual memory management unit for allocating a heap area of virtual memory corresponding to the heap area in the physical memory, and an address return unit for returning a heap allocation address to the user, and the heap allocation address includes heap authentication information, heap allocation address identification information, and heap size information.

Here, the heap area may include a heap header area and a heap body area.

Here, the heap allocation address may include the start address of the heap body area allocated in the physical memory.

Here, the heap authentication information may include most significant 7 bits and least significant 7 bits of a hash value generated based on previous heap authentication information, the heap size information, and a heap-allocation virtual address.

Here, the heap header area of the virtual memory may indicate previous heap authentication information and access permission information, the heap body area of the virtual memory may indicate the heap size information and access permission information, and the heap size information in the heap body area may correspond to a heap offset (heap_offset) value defined in 16-byte increments.

Here, the heap size information may correspond to 1-bit information that indicates 1 when the size of the allocated heap area is greater than a preset size and that indicates 0 when the size of the allocated heap area is equal to or less than the preset size.

Here, when access to the heap area in the physical memory occurs, the physical memory management unit may check access permission information in the virtual memory corresponding to the physical memory and block the access based on the access permission information.

Here, when access to the heap area in the physical memory occurs, the virtual memory management unit may calculate the address of the header area of the virtual memory using heap size information in the virtual memory, and when heap size information at the calculated address corresponds to ‘0000000’, the virtual memory management unit may determine that the address is not the header area of the virtual memory and again calculate the address of the header area of the virtual memory based on a multiple of ‘0x80’.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for detecting a security vulnerability of dynamic memory according to an embodiment of the present disclosure;

FIG. 2 is a configuration diagram of a 64-bit address according to an embodiment of the present disclosure;

FIGS. 3 and 4 illustrate virtual memory and physical memory areas after heap allocation in a method according to an embodiment of the present disclosure;

FIGS. 5 and 6 illustrate virtual memory and physical memory areas after heap deallocation in a method according to an embodiment of the present disclosure;

FIGS. 7 and 8 illustrate virtual memory and physical memory areas after heap reallocation in a method according to an embodiment of the present disclosure;

FIGS. 9 and 10 illustrate virtual memory and physical memory areas after heap greater than a specific size is allocated in a method according to an embodiment of the present disclosure;

FIGS. 11 to 16 are views for explaining a method for detecting a vulnerability according to an embodiment of the present disclosure;

FIGS. 17 to 22 are views for explaining a method for detecting a vulnerability according to another embodiment of the present disclosure;

FIG. 23 is a flowchart illustrating a process of setting heap allocation information when dynamic memory is allocated in a method according to an embodiment of the present disclosure;

FIG. 24 is a flowchart illustrating a process of setting heap allocation information when dynamic memory is deallocated in a method according to an embodiment of the present disclosure;

FIG. 25 is a block diagram illustrating an apparatus for detecting a security vulnerability of dynamic memory according to an embodiment of the present disclosure; and

FIG. 26 is a view illustrating the configuration of a computer system according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

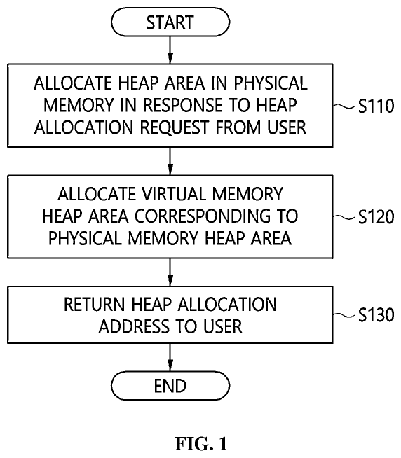

FIG. 1 is a flowchart illustrating a method for detecting a security vulnerability of dynamic memory according to an embodiment of the present disclosure.

The method for detecting a security vulnerability of dynamic memory according to an embodiment of the present disclosure may be performed by an apparatus for detecting a security vulnerability of dynamic memory, such as a computing device.

Referring to FIG. 1, the method for detecting a security vulnerability of dynamic memory according to an embodiment of the present disclosure includes allocating a heap area in physical memory in response to a heap allocation request from a user at step S110, allocating a heap area of virtual memory corresponding to the heap area in the physical memory at step S120, and returning a heap allocation address to the user at step S130, and the heap allocation address includes heap authentication information, heap allocation address identification information, and heap size information.

Here, the heap area may include a heap header area and a heap body area.

Here, the heap allocation address may include the start address of the heap body area allocated in the physical memory.

Here, the heap authentication information may include the most significant 7 bits and the least significant 7 bits of a hash value generated based on previous heap authentication information, heap size information, and a heap-allocation virtual address.

Here, the heap header area of the virtual memory may indicate the previous heap authentication information and access permission information, the heap body area of the virtual memory may indicate the heap size information and access permission information, and the heap size information in the heap body area may correspond to a heap offset (heap_offset) value defined in 16-byte increments.

Here, the heap size information may correspond to 1-bit information that indicates 1 when the size of the allocated heap area is greater than a preset size and that indicates 0 when the size of the allocated heap area is equal to or less than the preset size.

Here, in the method, when access to the heap area in the physical memory occurs, the access permission information in the virtual memory corresponding to the physical memory is checked, and the access may be blocked based thereon.

Here, in the method, when access to the heap area in the physical memory occurs, the address of the header area of the virtual memory is calculated using the heap size information in the virtual memory, and when the heap size information is 7 bits (b7˜b1) at the calculated address and corresponds to ‘0000000’, it is determined that the address is not the header area of the virtual memory, so the address of the header area of the virtual memory may be calculated again based on a multiple of ‘0x80’.

Here, the method may further include setting heap deallocation information in response to a heap deallocation request from the user, and setting the heap deallocation information may comprise filling the first 8 bytes of the heap body area of the physical memory corresponding to the heap deallocation request with a forward deallocated heap address, filling the second 8 bytes of the heap body area of the physical memory corresponding to the heap deallocation request with a backward deallocated heap address, and initializing the remaining heap body area to 0.

Here, setting the heap deallocation information may comprise updating the header area of the virtual memory corresponding to the heap deallocation request with previous heap authentication information and changing the access permission information in the body area of the virtual memory corresponding to the heap deallocation request to 0.

Here, the method may further include, after heap deallocation, reallocating a heap area in response to a heap reallocation request from the user, and reallocating the heap area may include reallocating the heap area in the physical memory, updating heap area reallocation information in the virtual memory corresponding to the reallocated physical memory, and returning the address of the reallocated heap to the user.

Here, updating the heap area reallocation information in the virtual memory may comprise maintaining the previous heap authentication information within the heap header area of the virtual memory and updating the heap body area of the virtual memory.

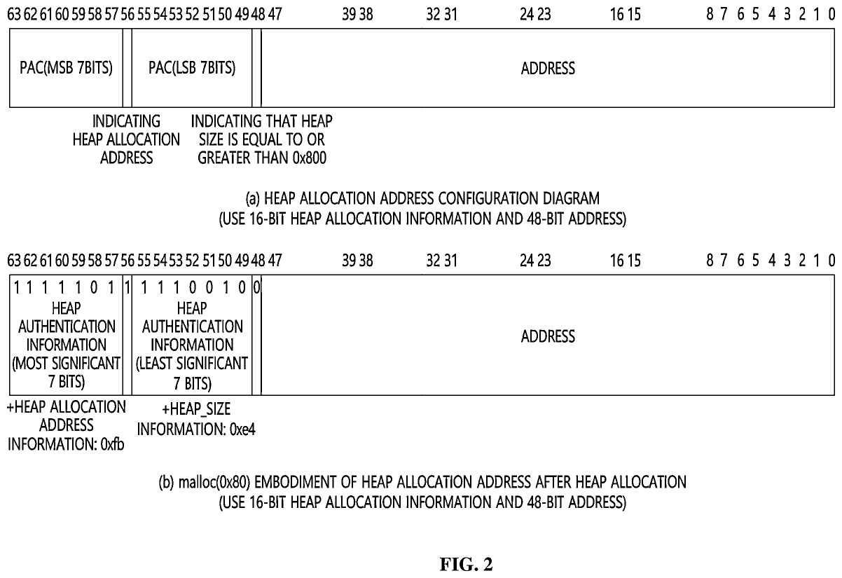

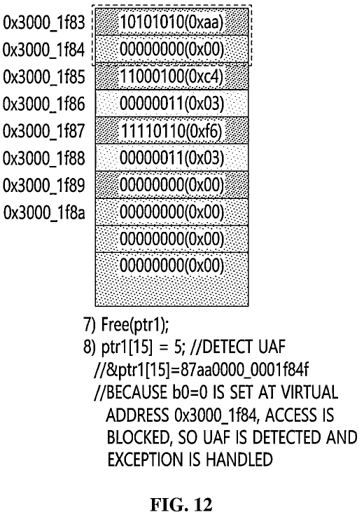

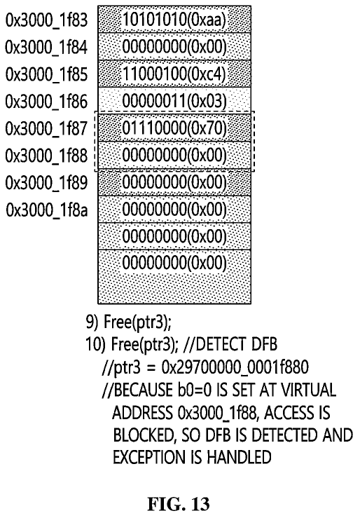

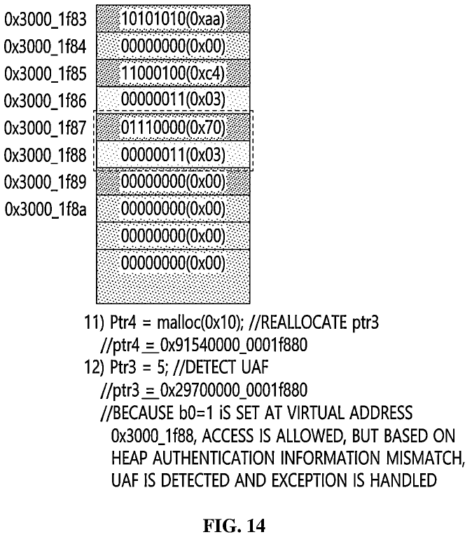

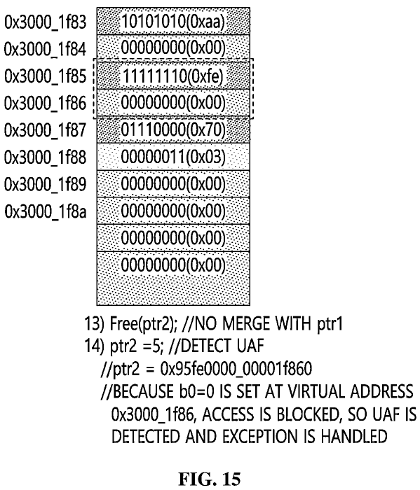

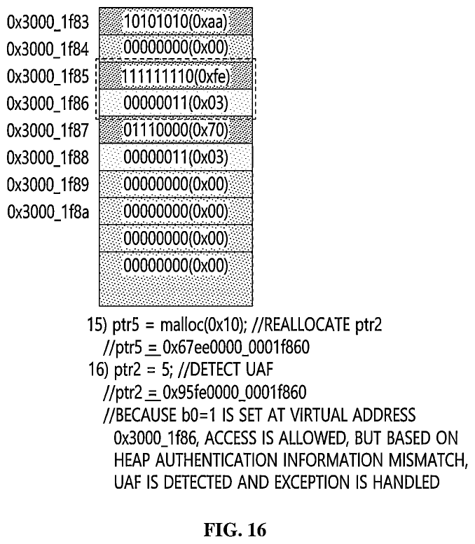

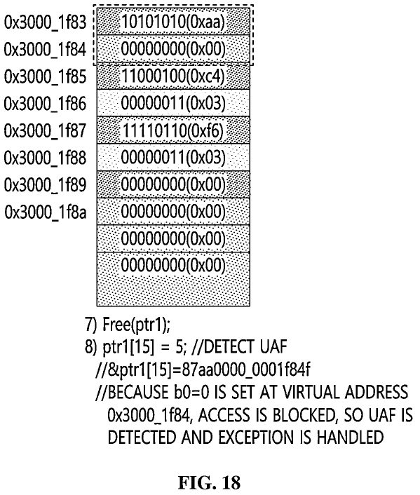

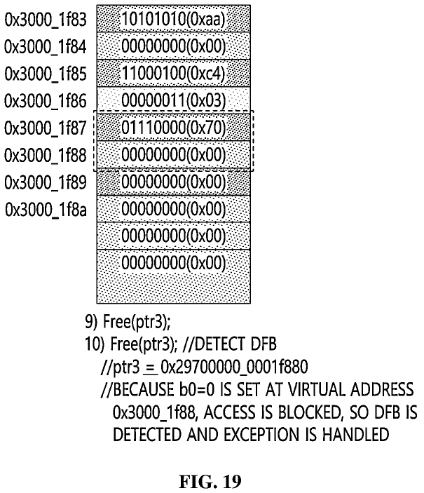

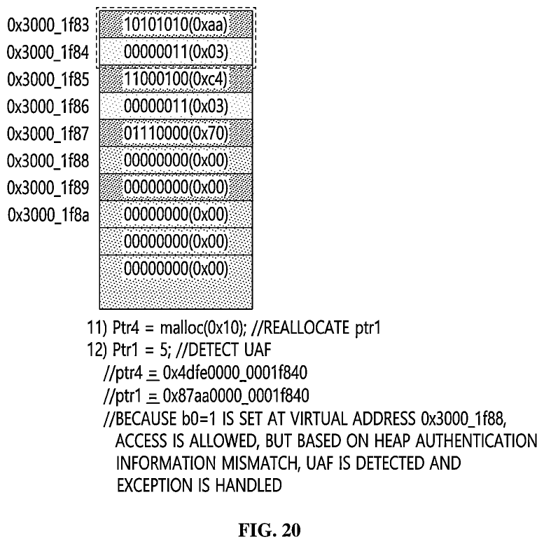

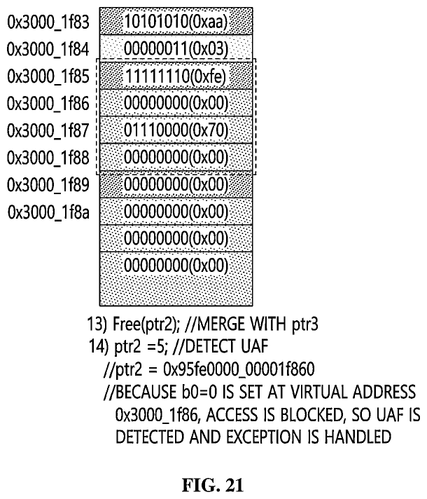

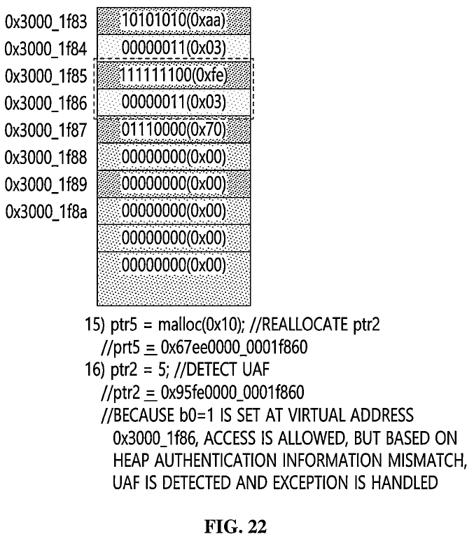

Hereinafter, an embodiment of the present disclosure will be described in more detail with reference to FIGS. 2 to 24.

A detailed description of the present disclosure includes a description of secure dynamic memory management using a heap area of physical memory, a heap area of virtual memory mapped thereto, and the reserved upper 16 bits of a 64-bit address format, which is used in a 64-bit computer system.

Also, a method for managing dynamic memory using heap allocation information set in a virtual memory area mapped to a physical memory area and a heap allocation address including the heap allocation information by accessing the virtual memory area before access to the physical memory area is described. In the present disclosure, the virtual memory area mapped to the physical memory area is 1/16 the size of the physical memory area, and the header and body of the heap area are mapped to the header and body of the virtual memory. In the present disclosure, the virtual memory area is defined as an address range of “0x3000_0000˜0x3fff_ffff”, and a virtual memory address mapped to a physical memory address is calculated by performing a 4-bit right shift operation (‘>>4’) on the lower 4 bytes of the physical memory address and adding 0x3000_0000, which is the base address of the virtual memory, thereto. Because heap is allocated in 16-byte increments in a 64-bit machine, the value of the lower 4 bits of the address is meaningless. Accordingly, 16 bytes of physical memory are mapped to 1 byte of virtual memory.

FIG. 2 is a configuration diagram of a 64-bit address according to an embodiment of the present disclosure.

FIG. 2 is an embodiment of the present disclosure and shows a configuration diagram of a 64-bit address that includes heap allocation information in a 64-bit address format used in a 64-bit computer system. (a) of FIG. 2 is an address format proposed in the present disclosure and shows the configuration of a heap allocation address in which, excluding the lower 48 bits for an address field, the upper 16 bits include 14-bit heap authentication information (bits b63˜57 and b55˜49), 1-bit heap allocation address identification information (bit b56, if the address is a heap allocation address, this bit is set to ‘1’ but if not, this bit is set to ‘0’), and 1-bit heap size information (bit b48, if a heap size is equal to or greater than 0x800, this bit is set to ‘1’ and if the heap size is less than 0x800, this bit is set to ‘0’).

(b) of FIG. 2 shows an example in which a new address including heap allocation information is returned when allocation of heap with the heap size ‘0x80’ is requested (ptr1=malloc (0x80);). In (b) of FIG. 2, the heap authentication information included in the address returned to a program (user) after heap allocation includes the most significant 7 bits and the least significant 7 bits of a hash value that is calculated by inputting the start address of a virtual memory body, which is mapped to the heap allocation address when the heap is allocated, the value at the start address of the virtual memory body (heap size information), the address of a virtual memory header, and the value of the virtual memory header (previous heap authentication information). Also, in (b) of FIG. 2, the heap allocation address identification information included in the address returned to the program (user) after heap allocation is set to ‘b56=1’ to indicate that the returned address is a heap allocation address. Also, in (b) of FIG. 2, the heap size information included in the address returned to the program (user) after heap allocation is used for the case in which a heap size is equal to or greater than ‘0x800’, but in this case, it is set to ‘b48=0’ because the heap size is ‘0x80’, which is less than ‘0x800’. Here, a hash value is calculated by inputting the start address of the virtual memory body mapped to the heap allocation address, the value at the start address of the virtual memory body (the heap size information), the address of the virtual memory header, and the value of the virtual memory header (the previous heap authentication information), and the most significant 7 bits and the least significant 7 bits of the calculated hash value are used as the heap authentication information.

The hash function (SHA256) used to generate heap authentication information in the present disclosure is an embodiment for describing the present disclosure. In order to generate heap authentication information, an algorithm similar to the hash function may also be used without limitation to the use of the hash function, and it is required to be implemented as hardware logic in consideration of performance. Here, previous heap authentication information is used as input to generate heap authentication information. Accordingly, even though heap is reallocated at the same address, different heap authentication information may be generated by always inputting different previous heap authentication information, and, using the heap authentication information generated in this way, a new address is returned each time, whereby a dangling pointer is prevented from being referenced. The following description shows a process of generating heap authentication information and generating a new heap allocation address including the generated heap authentication information when allocation of the heap with the heap size ‘0x80’ is requested (ptr1=malloc (0x80);).
start address of virtual memory body: 0x30001f84
value of virtual memory body: 7-bit heap size information+1-bit access permission information: 00000011 (0x03)
address of virtual memory header: 0x30001f83
value of virtual memory header: 7-bit previous heap authentication information (prev_pac (init_pac))+1-bit access permission information: 11010100 (0xd4)
input information: 0x30001f84//0x03//0x30001f83//0xd4
(start address of virtual memory body//value of virtual memory body//address of virtual memory header//value of virtual memory header)
hash value: FA7D2ED077C3F43D97B3DF617F5E713B6B0B09FA6E40397C4F2A440DE9233272
most significant 7 bits of heap authentication information (b63˜b57)+1-bit heap allocation address identification information (b56): 11111011 (0xfb)
least significant 7 bits of heap authentication information (b55˜b49)+1-bit heap size information (b48): 11100100 (0xc4)
new heap allocation address including heap authentication information: 0xfbe40000_0001f840

In the above description, the previous heap authentication information, which is one of the input values for generating the heap authentication information, uses initial heap authentication information when a corresponding address is an address at which heap is first allocated, and when heap is reallocated at the same address, previous heap authentication information set at the time of heap deallocation is used to generate and verify current heap authentication information. In the above description, the previous heap authentication information is described on the assumption that heap is first allocated. In this embodiment, a 7-bit arbitrary value (a randomly generated value) ‘1101010’ is used as the initial heap authentication information and is combined with ‘0 (access blocked)’, which is 1-bit access permission information for the heap header, whereby ‘11010100 (0xd4)’ is used as the previous heap authentication information (the initial heap authentication information). Accordingly, the hash value to be used as the heap authentication information is generated by inputting the start address of the virtual memory body (0x30001f84) mapped to the heap allocation address, the value at the start address of the virtual memory body (0x03, the heap size information), the address of the virtual memory header (0x30001f83), and the value of the virtual memory header (0xd4, the previous heap authentication information). The bits b63˜b56 of the heap allocation address are configured with ‘11111011 (0xfb)’ by combining the most significant 7 bits (1111101) of the generated hash value ‘FA7D2ED077C3F43D97B3DF617F5E713B6B0B09FA6E40397C4F2A440DE923327 2’ and the 1-bit heap allocation address identification information (1, indicating that the address is a heap allocation address), the bits b55˜b48 of the heap allocation address are configured with ‘11100100 (0xe4)’ by combining the least significant 7 bits (1110010) of the hash value and the 1-bit heap size information (0, indicating the heap size less than 0x800), and the bits b47˜b0 of the heap allocation address are configured with the 48-bit address (0x00000000_0001f840), whereby ‘0xfbe40000_0001f840’ is generated as a new heap allocation address including the heap allocation information and is returned to the program (user).

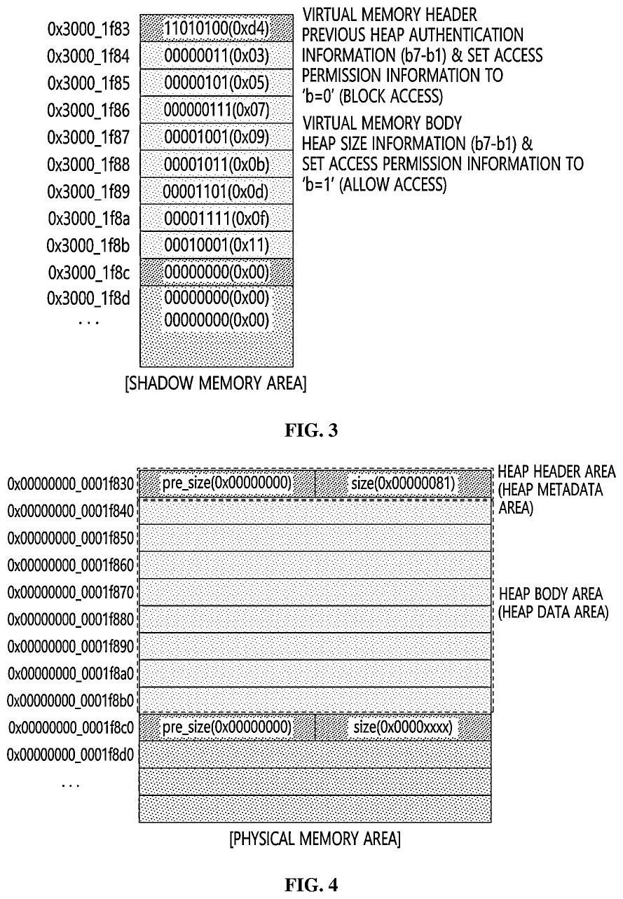

FIG. 3 and FIG. 4 illustrate virtual memory and physical memory areas after heap allocation in a method according to an embodiment of the present disclosure.

FIGS. 3 and 4 are another embodiment according to the present disclosure for accomplishing the above objects and show a process of setting a returned address and heap allocation information in the header area of virtual memory mapped to a physical memory address after a program (user) makes a heap allocation request with ‘ptr1=malloc(0x80);’.

Generally, when a heap area is allocated, the allocated heap area is divided into a heap header area and a heap body area, and the address returned to the program (user) after heap allocation is the start address of the heap body area that is used as a data area. Also, when the heap area is allocated, the virtual memory area mapped to the physical memory area is also divided into a header and a body, and FIG. 3 and FIG. 4 show the configuration of the virtual memory area and the configuration of the physical memory area, respectively. FIG. 4 is the configuration diagram of physical memory when heap is allocated with the heap size ‘0x80’, in which case the address returned to the program (user) is ‘0x00000000_0001f840’, which is the start address of the heap body area used as the data area, and the heap allocation information described in FIG. 2 is added to this address, whereby ‘0xfbe40000_0001f840’ is returned as a new heap allocation address.

After heap allocation, the virtual memory mapped to the physical memory is accessed before access to the physical memory, and whether to allow access to the heap area is determined by comparing the heap allocation information set in the virtual memory with the heap allocation information included in the address for accessing the heap area. FIG. 3 shows the configuration information in the virtual memory area mapped to the physical memory area after heap allocation. Because 16 bytes of physical memory are mapped to 1 byte of virtual memory, a 16-byte heap header area and a 128-byte heap body area in the physical memory are mapped to a 1-byte header area of the virtual memory and an 8-byte body area of the virtual memory, respectively, as shown in FIG. 3.

In FIG. 3, the header area of the virtual memory is 1 byte, which includes 7-bit previous heap authentication information (b7˜b1) and 1-bit access permission information (b0). In the present disclosure, the 1-bit access permission information (b0) is set to ‘b0=0’ to block access and is set to ‘b0=1’ to allow access. Also, the 7-bit previous heap authentication information (b7˜b1) is the heap authentication information used to authenticate the accessed address. Here, the address of the header of the virtual memory is calculated by subtracting the heap offset (heap_offset) stored in the body of the virtual memory from the address of the body of the virtual memory, and the value stored in the header of the virtual memory is the previous heap authentication information.

In an embodiment of the present disclosure, the heap authentication information is described based on an example in which a hash value is calculated by inputting the start address of a virtual memory body, the value stored at the start address of the virtual memory body (heap size information), the address of a virtual memory header, and the value stored in the virtual memory header (previous heap authentication information) and in which the most significant 7 bits and the least significant 7 bits of the calculated hash value are used as the heap authentication information.

For an address at which heap is first allocated, initial heap authentication information is used as previous heap authentication information for calculating heap authentication information, and when heap is reallocated at the same address, the previous heap authentication information is used to generate and verify current heap authentication information. Here, the previous heap authentication information that is used is the least significant 7 bits of the previous heap authentication information.

The previous heap authentication information (the initial heap authentication information) for setting the header area of the virtual memory in FIG. 3 is the above-described previous heap authentication information (initial heap authentication), and the 7-bit value ‘1101010’ is used as the previous heap authentication information. Also, the 1-bit access permission information is the access permission information for the heap header area, which is an area that should not be accessed by the program (user), so it is set to ‘b0=0’ to block access. Accordingly, in FIG. 3, the header area of the virtual memory is set to ‘11010100 (0xd4)’ by combining the 7-bit previous heap authentication information (b7˜b1=1101010) and the 1-bit access permission information (b0=0).

In FIG. 3, because the heap size is 128 (0x80) bytes, the body area of the virtual memory is configured with 8 bytes (0x30001f84˜0x30001f8b) and each byte includes 7-bit heap size information and 1-bit access permission information. The 1-bit access permission information is the access permission information for the heap body area, which is a data area used by the program (user), so access is allowed by setting the access permission information to ‘b0=1’. Also, the 7-bit heap size information is an offset value based on the header address of the virtual memory and is set to a heap offset (heap_offset) value defined in 16-byte increments. That is, when the heap size is 16 bytes, the heap offset (heap_offset) is ‘1’, and when the heap size is 128 bytes, the heap offset (heap_offset) is ‘8’.

Therefore, when heap is allocated with the heap size ‘128 (0x80)’, the start address of the body area of the virtual memory mapped to the start address of the heap body of the physical memory, ‘0x00000000_0001f840’, is ‘0x30001f84’, and the 7-bit heap size information (b7˜b1) at the address ‘0x30001f84’ is set to ‘0000001’ because it has an offset of ‘1’ from the header of the virtual memory. Also, the value at the start address ‘0x30001f84’ of the body of the virtual memory in FIG. 3 is set to ‘00000011 (0x03)’ by combining the 7-bit heap size information (b7˜b1=0000001) and the 1-bit access permission information (b0=1). In this way, the values of the 7-bit heap size information (b7˜b1) in the remaining 7 bytes of the body of the virtual memory are set to ‘0x30001f85=0000010’, ‘0x30001f86=0000011’, ‘0x30001f87=0000100’, ‘0x30001f88=0000101’, ‘0x30001f89-0000110’, ‘0x30001f8a=0000111’, and ‘0x30001f8b=0001000’, and the 1-bit access permission information (b) is set to ‘b0=1’ to allow access

Accordingly, the remaining 7 bytes of the body area of the virtual memory are set to ‘0x30001f85=00000101 (0x05)’, ‘0x30001f86=00000111 (0x07)’, ‘0x30001f87=00001001 (0x09)’, ‘0x30001f88=00001011 (0x0b)’, ‘0x30001f89=00001101 (0x0d)’, ‘0x30001f8a=00001111 (0x0f)’, and ‘0x30001f8b=00010001 (0x11)’ by combining the 7-bit heap size information (b7˜b1) and the 1-bit access permission information (b0).

When the heap body area is accessed after the virtual memory area is set as shown in FIG. 3, the 1-bit access permission information (b0) in the virtual memory area is checked first. When the 1-bit access permission information is ‘b0=0’, access is blocked and exception handling is triggered, whereas when the 1-bit access permission information is ‘b0=1’, the heap offset (heap_offset) of the virtual memory mapped to the accessed address is checked, and heap authentication information is generated using the address of the header of the virtual memory, the previous heap authentication information stored in the header of the virtual memory, the start address of the body of the virtual memory, and the heap size information stored at the start address of the body of the virtual memory, after which the generated heap authentication information is verified by comparing the same with the heap authentication information included in the accessed address. When the generated heap authentication information and the heap authentication information included in the accessed address match each other, the access is allowed, whereas when they do not match, the access is blocked, and exception handling is triggered.

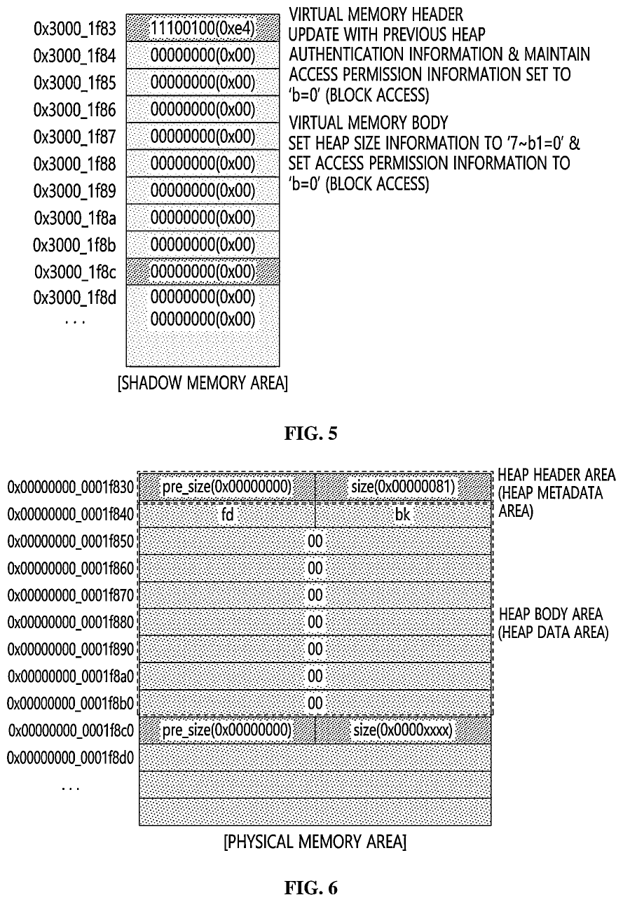

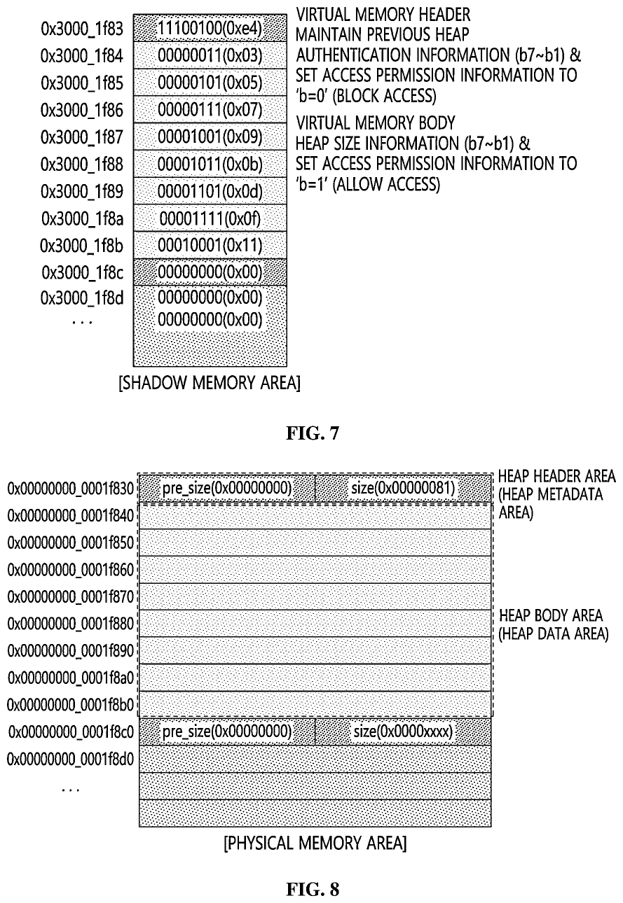

FIG. 5 and FIG. 6 illustrate virtual memory and physical memory areas after heap deallocation in a method according to an embodiment of the present disclosure.

FIG. 5 and FIG. 6 show another embodiment according to the present disclosure for accomplishing the above objects and show a process of setting heap deallocation information in the header area of virtual memory mapped to a physical memory address when heap allocated in the physical memory is deallocated. FIG. 6 shows a physical memory configuration diagram for the case in which heap is allocated with a heap size of ‘0x80’ as shown in FIG. 4 and is then deallocated.

In FIG. 6, after heap deallocation, the first 8 bytes of a heap body area is filled with a forward deallocated heap address, the second 8 bytes thereof is filled with a backward deallocated heap address, and the remaining heap body area is initialized to 0. After that, a program (user) should be prevented from accessing the deallocated heap area. FIG. 5 shows the virtual memory area mapped to the physical memory area after heap deallocation. In FIG. 5, the header area of the virtual memory is 1 byte and includes 7-bit previous heap authentication information (b7˜b1) and 1-bit access permission information (b0). The 1-bit access permission information (b0) in the header area of the virtual memory is the access permission information for a heap header area that should be prevented from being accessed by the program (user), so access is blocked by maintaining the access permission information (‘b0=0’) that was set when the heap was allocated.

Also, the 7-bit heap authentication information (b7˜b1) is set by updating the same with previous heap authentication information.

That is, the previous heap authentication information in FIG. 5 is ‘1110010’ that is the least significant 7 bits of the heap authentication information described above. Accordingly, the header area of the virtual memory in FIG. 5 is set to ‘11100100 (0xc4)’ by combining the 7-bit previous heap authentication information (b7˜b1=1110010) and the 1-bit access permission information (b0=0).

In FIG. 5, the body area of the virtual memory is configured with 8 bytes because the heap size is 128 (0x80) bytes, and each byte includes 7-bit heap size information and 1-bit access permission information. The 1-bit access permission information (b0) of each byte is the access permission information for a heap body area that is a data area used by the program (user), but because the heap body area is deallocated, access thereto is blocked by setting the access permission information to ‘b0=0’. Also, the 7-bit heap size information (b7˜b1) of each byte is an offset value based on the address of the header of the virtual memory and is set to a heap offset (heap_offset) value defined in 16-byte increments. After heap deallocation, the offset is set to ‘heap_offset=0’ in all of the 8 bytes. Accordingly, the body area of the virtual memory in FIG. 5 is set to ‘00000000 (0x00)’ by combining the 7-bit heap size information (b7˜b1=0000000) and the 1-bit access permission information (b0=0).

When the heap body area is accessed after the virtual memory area is set as shown in FIG. 5, the 1-bit access permission information (b0) in the virtual memory area is checked first. When the 1-bit access permission information is ‘b0=0’, access is blocked and exception handling is triggered, whereas when the 1-bit access permission information is ‘b0=1’, the heap offset (heap_offset) of the virtual memory mapped to the accessed address is checked, heap authentication information is generated using the previous authentication information stored in the header of the virtual memory, and the generated heap authentication information is verified by comparing the same with the heap authentication information included in the accessed address. When the generated heap authentication information and the heap authentication information included in the accessed address match each other, the access is allowed, whereas when they do not match, the access is blocked, and exception handling is triggered.

FIG. 7 and FIG. 8 illustrate virtual memory and physical memory areas after heap reallocation in a method according to an embodiment of the present disclosure.

FIGS. 7 and 8 are another embodiment according to the present disclosure for accomplishing the above objects and show a process of setting a returned address and heap allocation information in the header area of virtual memory mapped to a physical memory address when a program (user) requests reallocation of heap with ‘ptr2=malloc(0x80);’ after allocation and deallocation of heap having the same size. FIG. 7 shows the configuration of a virtual memory area after heap reallocation, and FIG. 8 shows the configuration of a physical memory area after heap reallocation. FIG. 8 shows a configuration diagram of physical memory when heap is reallocated in the state in which there is a heap area capable of being reallocated with a requested heap size ‘0x80’.

Therefore, heap having the same heap size is reallocated at the same physical address, and the configuration diagram is identical to the physical memory configuration diagram shown after heap allocation illustrated in FIG. 4. That is, the address returned to the program (user) after heap reallocation is ‘0x00000000_0001f840’, which is the start address of the heap body area used as a data area, and this address is the same as the physical address shown in FIG. 4. However, in order to return a different address each time heap is allocated, not this address but ‘0xf1920000_0001f840’ is returned as a new heap allocation address by including the heap allocation information described in the present disclosure.

After heap reallocation, virtual memory mapped to physical memory is accessed before access to the physical memory, and 1-bit access permission information (b0) is checked first, after which the heap allocation information set in the virtual memory is verified by comparing the same with heap allocation information included in the address for accessing the heap area in order to determine whether the access is allowed.

FIG. 7 shows the configuration of a virtual memory area mapped to a physical memory area after heap reallocation. Because 16 bytes of physical memory are mapped to 1 byte of virtual memory, the virtual memory area in FIG. 7 is configured with a 1-byte header area of the virtual memory and an 8-byte body area of the virtual memory, as in FIG. 3.

First, in FIG. 7, the header area of the virtual memory is configured with 7-bit previous heap authentication information and 1-bit access permission information. The 7-bit previous heap authentication information is the heap authentication information that was used when heap was previously allocated, and the 7-bit heap authentication information is used to calculate a hash value for authentication of an accessed address. When the heap is reallocated, current heap authentication information is generated and verified using the previous heap authentication information. However, as described in FIG. 5, the previous heap authentication information in the header area of the virtual memory in FIG. 7 has been updated to the 7-bit previous heap authentication information (b7˜b1=1110010) when the heap was deallocated, so the existing heap authentication information set at the time of heap deallocation is maintained when the heap is reallocated.

The 1-bit access permission information is the access permission information for the heap header area, and because the heap header should not be accessed by a program (user), access is blocked by maintaining the existing value set to ‘b0=0’. Therefore, in FIG. 7, the header area of the virtual memory retains the previously set value, ‘11100100 (0xc4)’, by combining the existing 7-bit previous heap authentication information (b7˜b1=1110010) and the 1-bit access permission information (b0=0).

In FIG. 7, the body area of the virtual memory is configured with 8 bytes (0x30001f84˜0x30001f8b) because the heap size is 128 (0x80) bytes, and each byte includes 7-bit heap size information and 1-bit access permission information. However, because heap is reallocated with the same size at the same physical address as the allocated heap area in FIGS. 3 and 4, the body area of the virtual memory is set to be the same as that shown in FIG. 3. The 1-bit access permission information is the access permission information for the heap body area that is a data area used by the program (user), so the 1-bit access permission information is set to ‘b0=1’ to allow access. Also, the 7-bit heap size information is an offset value based on the address of the header of the virtual memory and is set to a heap offset (heap_offset) value defined in 16-byte increments.

That is, when the heap size is 16 bytes, the heap offset (heap_offset) is ‘1’, and when the heap size is 128 bytes, the heap offset (heap_offset) is ‘8’. Accordingly, when heap with a heap size of ‘128 (0x80)’ is reallocated, the start address of the body of the virtual memory mapped to ‘0x00000000_0001f840’, which is the start address of the heap body of the physical memory, is ‘0x30001f84’, and the 7-bit heap size information (b7˜b1) at ‘0x30001f84’ is set to ‘0000001’ because it has an offset of ‘1’ from the header of the virtual memory.

Also, in FIG. 7, the value at ‘0x30001f84’, which is the start address of the body of the virtual memory, is set to ‘00000011 (0x03)’ by combining the 7-bit heap size information (b7˜b1=0000001) and the 1-bit access permission information (b0=1). In this way, the values of the 7-bit heap size information (b7˜b1) of the remaining 7 bytes are set to ‘0x30001f85=0000010’, ‘0x30001f86=0000011’, ‘0x30001f87=0000100’, ‘0x30001f88=0000101’, ‘0x30001f89-0000110’, ‘0x30001f8a=0000111’, and ‘0x30001f8b=0001000’, and the 1-bit access permission information (b0) is set to ‘b0=1’ to allow access. Therefore, the remaining 7 bytes of the body area of the virtual memory are set to ‘0x30001f85-00000101 (0x05)’, ‘0x30001f86=00000111 (0x07)’, ‘0x30001f87=00001001 (0x09)’, ‘0x30001f88=00001011 (0x0b)’, ‘0x30001f89=00001101 (0x0d)’, ‘0x30001f8a=00001111 (0x0f)’, and ‘0x30001f8b=00010001 (0x11)’ by combining the 7-bit heap size information (b7˜b1) and the 1-bit access permission information (b0)

When the heap body area is accessed after the virtual memory area is set as shown in FIG. 7, the 1-bit the access permission information (b0) in the virtual memory area is checked first. When the 1-bit access permission information is ‘b0=0’, access is blocked and exception handling is triggered, whereas when the 1-bit access permission information is ‘b0=1’, the heap offset (heap_offset) of the virtual memory mapped to the accessed address is checked, and heap authentication information is generated using the previous authentication information stored in the header of the virtual memory and is verified by comparing the same with the heap authentication information included in the accessed address. When the generated heap authentication information and the heap authentication information included in the accessed address match each other, the access is allowed, whereas when they do not match, the access is blocked, and exception handling is triggered.

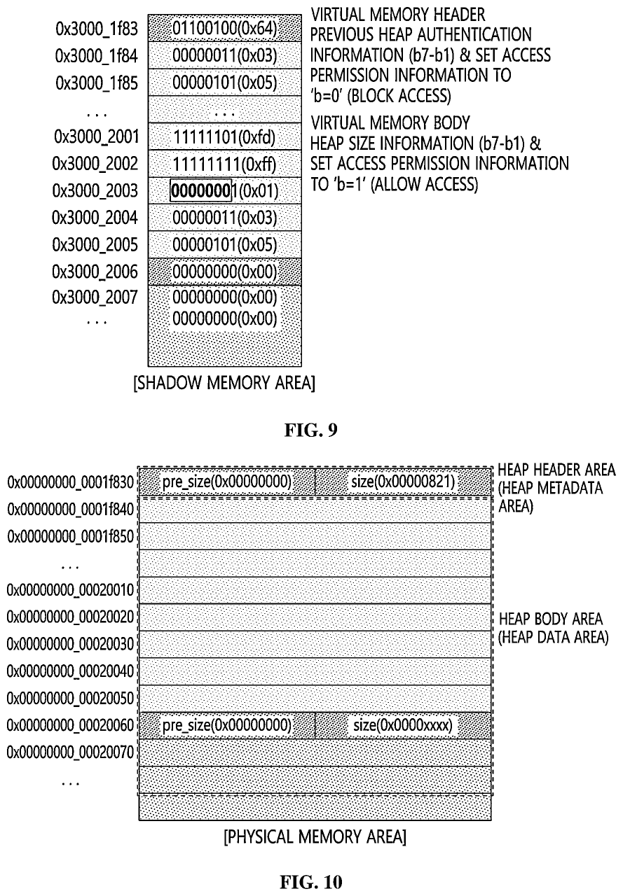

FIG. 9 and FIG. 10 illustrate virtual memory and physical memory areas after heap greater than a specific size is allocated in a method according to an embodiment of the present disclosure.

FIG. 9 and FIG. 10 are another embodiment according to the present disclosure for accomplishing the above objects and show a process of setting a returned address and heap allocation information in the header area of virtual memory mapped to a physical memory address after a program (user) makes a heap allocation request with ‘ptr1=malloc(0x820);’. The heap allocation process described above in FIGS. 3 and 4 is an embodiment for the case in which allocation of heap with a heap size of ‘0x80’, which is less than ‘0x800’, is requested, and FIG. 9 and FIG. 10 are an embodiment for the case in which allocation of heap with a heap size equal to or greater than ‘0x800’ is requested.

According to the present disclosure, a heap offset (heap_offset) that is heap size information set in the body of virtual memory is 7 bits, and the possible maximum value thereof is ‘1111111 (0x7F)’. This means that the heap size can only be up to ‘0x7f0’. However, it is possible allocate heap having a heap size equal to or greater than ‘0x800’, and in order to explain this, an embodiment for the case in which heap with a heap size of ‘0x820’ is allocated will be described with reference to FIGS. 9 and 10.

FIG. 10 is a configuration diagram of physical memory when heap with the heap size ‘0x820’ is allocated. Here, the address returned to a program (user) is ‘0x00000000_0001f840’ that is the start address of a heap body area used as a data area, and the heap allocation information described in FIG. 2 is added to this address, whereby ‘0x87ab0000 0001f840’ is returned as a new heap allocation address. In order to add the heap allocation information to the heap allocation address, ‘01100100 (0x64)’, which is a combination of ‘0110010’, which is a 7-bit arbitrary value (a randomly generated value) used as previous heap authentication information (initial heap authentication information), and ‘0 (access blocked)’, which is 1-bit access permission information for the heap header, is used in the embodiment of FIGS. 9 and 10. Also, the hash value to be used as heap authentication information is generated by inputting the start address of the body of the virtual memory mapped to the heap allocation address (0x30001f84), the value at the start address of the body of the virtual memory (0x03, heap size information), the address of the header of the virtual memory (0x30001f83), and the value of the header of the virtual memory (0x64, the previous heap authentication information). The bits b63˜b56 of the heap allocation address are configured with ‘10000111 (0x87)’ by combining the most significant 7 bits (1000011) of the generated hash value ‘875EC87B380639D2B21A6D6D4457991938B146A55A052E60DED576B658713CD5’ and 1-bit heap allocation address identification information (1, indicating that the address is a heap allocation address), the bits b55˜b48 of the heap allocation address are configured with ‘10101011 (0xab)’ by combining the least significant 7 bits (1010101) of the hash value and 1-bit heap size information (1, indicating the heap size equal to or greater than 0x800), and the bits b47˜b0 of the heap allocation address are configured with the 48-bit address (0x00000000_0001f840), whereby ‘0x87ab0000_0001f840’ is generated as a new heap allocation address including the heap allocation information and is returned to the program (user).

FIG. 9 shows configuration information in a virtual memory area mapped to a physical memory area after heap allocation. Because 16 bytes of physical memory are mapped to 1 byte of virtual memory, a 16-byte heap header area and a heap body area having a size of 0x820 bytes in the physical memory are mapped to a 1-byte header area and a body area having a size of 0x82 bytes in the virtual memory, respectively, as shown in FIG. 9. First, in FIG. 9, the 1-byte header area of the virtual memory includes 7-bit previous heap authentication information (b7˜b1) and 1-bit access permission information (b). In FIG. 9, the previous heap authentication information (initial heap authentication information) for setting the header area of the virtual memory uses a 7-bit arbitrary value (a randomly generated value), ‘0110010’, because the heap is first allocated as described above, and the 1-bit access permission information is the access permission information for the heap header area that should not be accessed by the program (user), so the access permission information is set to ‘b0=0’ to block access. Accordingly, in FIG. 9, the header area of the virtual memory is set to ‘01100100 (0x64)’ by combining the 7-bit previous heap authentication information (b7˜b1=0110010) and the 1-bit access permission information (b0=0).

In FIG. 9, the body area of the virtual memory is ‘0x30001f84˜0x30002005’ because it has a size of ‘0x82’ bytes, and each byte includes 7-bit heap size information and 1-bit access permission information. The 1-bit access permission information is the access permission information for the heap body area, and because the heap body is a data area used by the program (user), access is allowed by setting the 1-bit access permission information to ‘b0=1’. Also, the 7-bit heap size information is an offset value based on the address of the header of the virtual memory and is set to a heap offset (heap_offset) value defined in 16-byte increments. As described above, the value at ‘0x30001f84’, which is the start address of the body of the virtual memory, is set to ‘00000011 (0x03)’ by combining the 7-bit heap size information (b7˜b1=0000001) and the 1-bit access permission information (b0=1).

By increasing the heap offset value by 1 in this way, the value at the body address ‘0x30002002’ in the virtual memory is set to ‘11111111 (0xff)’ by combining the 7-bit heap size information (b7˜b1=1111111) and the 1-bit access permission information (b0=1), and the value at the body address ‘0x30002003’ in the virtual memory is set to ‘00000001 (0x01)’ by combining the 7-bit heap size information (b7˜b1=0000000) and the 1-bit access permission information (b0=1). Then, the value at the body address ‘0x30002004’ in the virtual memory is set to ‘00000011 (0x03)’ to be the same as the value set at ‘0x30001f84’ by combining the 7-bit heap size information (b7˜b1=0000001) and the 1-bit access permission information (b0=1), and the value at ‘0x30002005’ is set to ‘00000101 (0x05)’ to be the same as the value set at ‘0x30001f85’ by combining the 7-bit heap size information (b7˜b1=0000010) and the 1-bit access permission information (b0=1). That is, the heap offset value that increases by 1 from ‘0000001’ to ‘1111111’ is set at the body address of the virtual memory. Accordingly, when the heap offset value becomes ‘0000000’ again at ‘0x30002003’, ‘0000000’ is set, and then the heap offset value increases by 1 again, whereby ‘0000001’ and ‘0000010’ are set at ‘0x30002004’ and ‘0x30002005’, respectively. Table 1 below briefly shows the above process.

TABLE 1

0x30001f84=00000011(0x03), 0x30001f85=00000101(0x05),
... ,
0x30002001=11111101(0xfd), 0x30002002=11111111(0xff),
0x30002003=00000001(0x01),
0x30002004=00000011(0x03), 0x30002005=00000101(0x05)

When the heap body area is accessed after the virtual memory area is set as shown in FIG. 9, the 1-bit access permission information (b0) in the virtual memory area is checked first. When the 1-bit access permission information is ‘b0=0’, access is blocked and exception handling is triggered, whereas when the 1-bit access permission information is ‘b0=1’, the heap offset (heap_offset) of the virtual memory mapped to the accessed address is checked, and heap authentication information is generated using the previous authentication information stored in the header of the virtual memory and is verified by comparing the same with the heap authentication information included in the accessed address. When the generated heap authentication information and the heap authentication information included in the accessed address match each other, the access is allowed, whereas when they do not match, the access is blocked, and exception handling is triggered.

As an embodiment for the case in which the heap body area is accessed after the virtual memory area is set as shown in FIG. 9, the case in which the accessed heap area address is ‘0x87ab0000_00020030’ in FIG. 10 will be described. First, the virtual memory address mapped to the accessed address is ‘0x30002003’, and because the heap size information bit (b48) included in the accessed address is ‘1’, it is confirmed that the heap size is equal to or greater than ‘0x800’. Then, the 1-bit access permission information (b0) at the virtual memory address ‘0x30002003’ is checked, and because it is ‘b0=1’, the address of the header of the virtual memory is calculated using the heap size information (b7˜b1) stored at ‘0x30002003’. Here, if the heap size information (b7˜b1) is ‘0000000’, the address of the header of the virtual memory is calculated by determining the heap offset to be a multiple of ‘0x80’. Therefore, the address of the header of the virtual memory is calculated to be ‘0x30001f83’ by subtracting 0x80 from 0x30002003 (0x30002003-0x80), and if the access permission information at the calculated address ‘0x30001f83’ is ‘b0=0’, the calculated address is determined to be the header of the virtual memory.

When the header of the virtual memory is obtained, heap authentication information is generated using the previous heap authentication information (0x64) stored in the header area and is verified by comparing the same with the heap authentication information included in the address. Here, the heap authentication information is calculated by inputting 8-bit 01100100 (0x64), which is a combination of the previous heap authentication information 7-bit (0110010) and the access permission information 1-bit (0). The hash value to be used as the heap authentication information is generated by inputting the start address of the body of the virtual memory mapped to the heap allocation address (0x30001f84), the value at the start address of the body of the virtual memory (0x03, heap size information), the address of the header of the virtual memory (0x30001f83), and the value of the header of the virtual memory (0x64, the previous heap authentication information). Because the most significant 7 bits (1000011) and the least significant 7 bits (1010101) of the generated hash value ‘875EC87B380639D2B21A6D6D4457991938B146A55A052E60DED576B658713CD5’ match the heap authentication information ‘1000011(b63˜57)’ and ‘1010101(b55˜b49)’ included in the accessed address, access is allowed.

As another embodiment, the case in which the address of the accessed heap area is ‘0x87ab0000_00020050’ in FIG. 10 is described. First, the virtual memory address mapped to the accessed address is ‘0x30002005’, and because the heap size information bit (b48) included in the accessed address is ‘1’, it is confirmed that the heap size is equal to or greater than ‘0x800’. Accordingly, the 1-bit access permission information (b0) at the virtual memory address ‘0x30002005’ is checked, and because it is ‘b0=1’, the address of the header of the virtual memory is calculated using the heap size information (b7˜b1) stored at ‘0x30002005’. Using the heap size information (b7˜b1=0000010) stored at ‘0x30002005’, the address of the header of the virtual memory is calculated to be ‘0x30002003’ by subtracting 0x2 from 0x30002005 (0x30002005-0x2). When the access permission information at ‘0x30002003’, calculated as the header of the virtual memory, is ‘b0=1 (access allowed)’ and when the heap size information (b7˜b1) at the corresponding address is ‘0000000’, it is determined that the calculated address is not the header of the virtual memory, and the address of the header of the virtual memory is calculated again by setting the heap offset to a multiple of ‘0x80’. Accordingly, the address of the header of the virtual memory is calculated to be ‘0x30001f83’ by subtracting 0x80 from 0x30002003 (0x30002003-0x80), and if the 1-bit access permission information (b0) at ‘0x30001f83’ is ‘b0=0 (access blocked)’, the calculated address is determined to be the header of the virtual memory.

When the header of the virtual memory is obtained, heap authentication information is generated using the previous heap authentication information (0x64) stored in the header of the virtual memory and is verified by comparing the same with the heap authentication information included in the address. Here, the heap authentication information is calculated by inputting 8-bit 01100100 (0x64), which is a combination of the previous heap authentication information 7-bit (0110010) and the access permission information 1-bit (0). The hash value to be used as the heap authentication information is generated by inputting the start address of the body of the virtual memory mapped to the heap allocation address (0x30001f84), the value at the start address of the body of the virtual memory (0x03, heap size information), the address of the header of the virtual memory (0x30001f83), and the value of the header of the virtual memory (0x64, the previous heap authentication information). Because the most significant 7 bits (1000011) and the least significant 7 bits (1010101) of the generated hash value ‘875EC87B380639D2B21A6D6D4457991938B146A55A052E60DED576B658713CD5’ match the heap authentication information ‘1000011(b63˜57) and ‘1010101(b55˜b49)’ included in the accessed address, access is allowed.

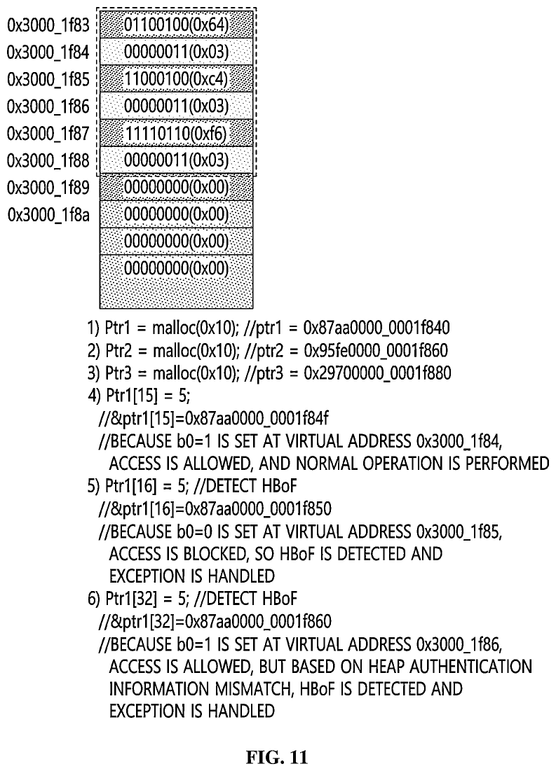

FIGS. 11 to 16 are views for explaining a method for detecting a vulnerability according to an embodiment of the present disclosure.

FIGS. 11 to 16 are another embodiment according to the present disclosure and show an embodiment for the case in which three dynamic memory areas having the same size are allocated, access within the range of the allocated memory area is made, access out of the range of the allocated memory area is made, access to a deallocated memory area is made after deallocation of the allocated dynamic memory, deallocation is attempted again after deallocation of the allocated dynamic memory, and access to a reallocated dynamic memory area is made with a previous pointer (address) after reallocation in the deallocated dynamic memory area.

In the present embodiment, the case in which, when a heap area is allocated and deallocated, even if there is a deallocated heap area adjacent thereto, the process proceeds without merging and in which the most recently deallocated heap area is reallocated is described. First, Table 2 below is an embodiment of a program that allocates three dynamic memory areas with the same heap size 16 (0x10) bytes and tests for whether Heap-based Buffer OverFlow (HBOF), Use After Free (UAF), and Double Free Bug (DFB) are detected.

TABLE 2
1) ptr1 = malloc(0x10);
2) ptr2 = malloc(0x10);
3) ptr3 = malloc(0x10);
4) ptr1[15] = 5; //access within heap area range
5) ptr1[16] = 5; //access out of heap area range (detect HboF)
6) ptr1[32] = 5; //access out of heap area range (detect HboF)
7) free(ptr1);
8) ptr1[15] = 5; //detect UAF
9) free(ptr3);
10) free(ptr3); //attempt Double Free
11) ptr4 = malloc(0x10); //reallocate in area to which ptr3 used to point
12) ptr3 = 5; //detect UAF
13) free(ptr2); //no merging with ptr1
14) ptr2 = 5; //detect UAF
15) ptr5 = malloc(0x10); //reallocate in area to which ptr2 used to point
16) ptr2 = 5; //detect UAF

FIGS. 11 to 16 show an embodiment of a new heap allocation address including heap allocation information that is returned to a program (user) after heap allocation, a virtual memory address mapped to physical memory, and heap allocation information stored in the header and body of a virtual memory area when the program of Table 2 is executed. Therefore, the embodiment based on execution of the program of Table 2 is described as follows.

1) ptr1=malloc(0x10);

In the heap allocation address including heap allocation information, a 7-bit arbitrary value (a randomly generated value), ‘b7˜b1=0110010’, is used as initial heap authentication information and is combined with 1-bit access permission information set to ‘b0=0 (access blocked)’ for a heap header, whereby ‘01100100 (0x64)’ is used as previous heap authentication information (the initial heap authentication information). Accordingly, the hash value to be used as heap authentication information is generated by inputting the start address of the body of the virtual memory mapped to the heap allocation address (0x30001f84), the value of the body of the virtual memory (0x03, heap size information), the address of the header of the virtual memory (0x30001f83), and the value of the header of the virtual memory (0x64, the previous heap authentication information). The bits b63˜b56 of the heap allocation address are configured with ‘10000111 (0x87)’ by combining the most significant 7 bits (1000011) of the generated hash value ‘875EC87B380639D2B21A6D6D4457991938B146A55A052E60DED576B658713CD5’ and 1-bit heap allocation address identification information (1, indicating that the address is a heap allocation address), the bits b55˜b48 of the heap allocation address are configured with ‘10101010 (0xaa)’ by combining the least significant 7 bits (1010101) of the hash value and 1-bit heap size information (0, indicating a heap size less than 0x800), and the bits b47˜b0 of the heap allocation address are configured with the 48-bit address (0x00000000_0001f840), whereby ‘0x87aa0000_0001f840’ is generated as a new heap allocation address including the heap allocation information and is returned to the program (user).

The header area of the virtual memory is configured with 1 byte, which includes the least significant 7 bits of the previous heap authentication information and access permission information set to ‘b0=0’ for the heap header to block access. The header area of the virtual memory is set to ‘01100100 (0x64)’ by combining the 7-bit previous heap authentication information (0110010) and the 1-bit access permission information (0) for the heap header.

Because the heap size is ‘0x10’, the body area of the virtual memory is configured with 1 byte and the heap offset thereof is ‘0x01’. Accordingly, the body area of the virtual memory is configured with the 7-bit heap offset (b7˜b1=0000001) and access permission information set to ‘b0=1’ for the heap body to allow access. The body area of the virtual memory is set to ‘00000011 (0x03)’ by combining the 7-bit heap offset (0000001) with the 1-bit access permission information (1) for the heap body.

2) ptr2=malloc(0x10);

In the heap allocation address including heap allocation information, a 7-bit arbitrary value (a randomly generated value), ‘b7˜b1=1100010’, is used as initial heap authentication information and is combined with access permission information set to ‘b0=0 (access blocked)’ for the heap header, whereby ‘11000100 (0xc4)’ is used as previous heap authentication information (the initial heap authentication information). Accordingly, the hash value to be used as heap authentication information is generated by inputting the start address of the body of the virtual memory mapped to the heap allocation address (0x30001f86), the value at the start address of the body of the virtual memory (0x03, heap size information), the address of the header of the virtual memory (0x30001f85), and the value of the header of the virtual memory (0xc4, the previous heap authentication information). The bits b63˜b56 of the heap allocation address are configured with ‘10010101 (0x95)’ by combining the most significant 7 bits (1001010) of the generated hash value ‘9423F8312BACFFF6CD855BF758A37F179C2BE69AA4FACB698980E5904A93247 F’ with 1-bit heap allocation address identification information (1, indicating that the address is a heap allocation address), the bits b55˜b48 of the heap allocation address are configured with ‘11111110 (0xfe)’ by combining the least significant 7 bits (1111111) of the hash value with 1-bit heap size information (0, indicating a heap size less than 0x800), and the bits b47˜b0 of the heap allocation address are configured with the 48-bit address (0x00000000_0001f860), whereby ‘0x95fe0000_0001f860’ is generated as a new heap allocation address including the heap allocation information and is returned to the program (user).

The header area of the virtual memory is configured with 1 byte, which includes the least significant 7 bits of previous heap authentication information and access permission information set to ‘b0=0’ for the heap header to block access. The header area of the virtual memory is set to ‘11000100 (0xc4)’ by combining the 7-bit previous heap authentication information (1100010) with the 1-bit access permission information (0) for the heap header.

Because the heap size is ‘0x10’, the body area of the virtual memory is configured with 1 byte, and the heap offset thereof is ‘0x01’. Accordingly, the body area of the virtual memory includes the 7-bit heap offset (b7˜b1=0000001) and 1-bit access permission information set to ‘b0=1’ for the heap body to allow access. Therefore, the body area of the virtual memory is set to ‘00000011 (0x03)’ by combining the 7-bit heap offset (0000001) and the 1-bit access permission information (1) for the heap body.

3) ptr3=malloc(0x10);

In the heap allocation address including heap allocation information, a 7-bit arbitrary value (a randomly generated value), ‘b7˜b1=1111011’, is used as initial heap authentication information and is combined with access permission information set to ‘b0=0 (access blocked)’ for the heap header, whereby ‘11110110 (0xf6)’ is used as previous heap authentication information (the initial heap authentication information). Accordingly, the hash value to be used as heap authentication information is generated by inputting the start address of the body of the virtual memory mapped to the address of the allocated heap (0x30001f88), the value at the start address of the body of the virtual memory (0x03, heap size information), the address of the header of the virtual memory (0x30001f87), and the value of the header of the virtual memory (0xf6), the previous heap authentication information). The bits b63˜b56 of the heap allocation address are configured with ‘00101001 (0x29)’ by combining the most significant 7 bits (0010100) of the generated hash value ‘29235F9BC7AF1ED5B4B39398B1D383EF92C61CDB946509A01644BE0B066388B 8’ with 1-bit heap allocation address identification information (1, indicating that the address is a heap allocation address), the bits b55˜b48 of the heap allocation address are configured with ‘01110000 (0x70)’ by combining the least significant 7 bits (0111000) with 1-bit heap size information (0, indicating a heap size less than 0x800), and the bits b47˜b0 of the heap allocation address are configured with the 48-bit address (0x00000000_0001f880), whereby ‘0x29700000_0001f880’ is generated as a new heap allocation address including the heap allocation information and is returned to the program (user).

The header area of the virtual memory is configured with 1 byte, which includes the least significant 7 bits of the previous heap authentication information and access permission information set to ‘b0=0’ for the heap header to block access. The header area of the virtual memory is set to ‘11110110 (0xf6)’ by combining the 7-bit previous heap authentication information (1111011) with the 1-bit access permission information (0) for the heap header.

Because the heap size ‘0x10’, the body area of the virtual memory is configured with 1 byte, and the heap offset thereof is ‘0x01’. Accordingly, the body area of the virtual memory includes the 7-bit heap offset (b7˜b1=0000001) and 1-bit access permission information set to ‘b0=1’ for the heap body to allow access. Therefore, the body area of the virtual memory is set to ‘00000011 (0x03)’ by combining the 7-bit heap offset (0000001) with the 1-bit access permission information (1) for the heap body.

4) ptr1[15]=5; //Access within Heap Area Range

After checking the access permission information (b0) in the virtual memory area (0x30001f84) mapped to the accessed address (0x87aa0000_0001f840), because the access permission information is ‘b0=1’, it is determined that access is allowed, the address of the header of the virtual memory is calculated by checking and using the heap offset (heap_offset), ‘0x01’, which is the heap size information stored in the body area of the virtual memory, and previous heap authentication information is obtained. Because the address of the header of the virtual memory is ‘0x30001f83’ (0x30001f84-0x01), the previous heap authentication information (prev_pac) stored at the address of the header of the virtual memory is ‘0x64’. Therefore, the hash value to be used as heap authentication information is generated by inputting the start address of the body of the virtual memory mapped to the heap allocation address (0x30001f84), the value at the start address of the body of the virtual memory (0x03, the heap size information), the address of the header of the virtual memory (0x30001f83), and the value of the header of the virtual memory (0x64, the previous heap authentication information). Because the most significant 7 bits ‘1000011’ and the least significant 7 bits ‘1010101’ of the generated hash value ‘875EC87B380639D2B21A6D6D4457991938B146A55A052E60DED576B658713CD5’ match the heap authentication information ‘1000011(b63˜b57)’ and ‘1010101(b55˜b49)’ included in the accessed address, the access is allowed.

5) ptr1[16]=5; //Access Out of Heap Area Range (Detect HBoF)

After checking the access permission information (b0) in the virtual memory area (0x30001f85) mapped to the accessed address (0x87aa0000_0001f850), because the access permission information is ‘b0=0’, the access is blocked, and the exception is handled. Because the virtual memory area mapped to the accessed address is the header area of the virtual memory, the access is blocked, and the exception is handled, whereby Heap-based Buffer OverFlow is detected normally.

6) ptr1[32]=5; //Access Out of Heap Area Range (Detect HBoF)

After checking the access permission information (b0) in the virtual memory area (0x30001f86) mapped to the accessed address (0x87aa0000_0001f860), because the access permission information is ‘b0=1’, it is determined that access is allowed, the address of the header of the virtual memory is calculated by checking and using the heap offset (heap_offset), ‘0x01’, which is the heap size information stored in the body area of the virtual memory, and previous heap authentication information is obtained. Because the address of the header of the virtual memory is ‘0x30001f85’ (0x30001f86-0x01), the previous heap authentication information (prev_pac) stored at the address of the header of the virtual memory is ‘0xc4’. Accordingly, the hash value to be used as heap authentication information is generated by inputting the start address of the body of the virtual memory mapped to the heap allocation address (0x30001f86), the value at the start address of the body of the virtual memory (0x03, the heap size information), the address of the header of the virtual memory (0x30001f85), and the value of the header of the virtual memory (0xc4, the previous heap authentication information). Because the most significant 7 bits ‘1001010’ and the least significant 7 bits ‘1111111’ of the generated hash value ‘9423F8312BACFFF6CD855BF758A37F179C2BE69AA4FACB698980E5904A93247 F’ do not match the heap authentication information ‘1000011(b63˜b57)’ and ‘0101010(b55˜b49)’ included in the accessed address, the access is blocked, and the exception is handled, whereby Heap-based Buffer OverFlow is detected normally.

### 7) Free(ptr1);

After checking the access permission information (b0) in the virtual memory area (0x30001f84) mapped to the accessed address (0x87aa0000_0001f840), because the access permission information is ‘b0=1’, it is determined that the access is allowed, the address of the header of the virtual memory is calculated by checking and using the heap offset (heap_offset), ‘0x01’, which is the heap size information stored in the body area of the virtual memory, and previous heap authentication information is obtained. Because the address of the header of the virtual memory is ‘0x30001f83’ (0x30001f84-0x01), the previous heap authentication information (prev_pac) stored at the address of the header of the virtual memory is ‘0x64’. Accordingly, the hash value to be used as heap authentication information is generated by inputting the start address of the body of the virtual memory mapped to the heap allocation address (0x30001f84), the value at the start address of the body of the virtual memory (0x03, the heap size information), the address of the header of the virtual memory (0x30001f83), and the value of the header of the virtual memory (0x64, the previous heap authentication information). Because the most significant 7 bits ‘1000011’ and the least significant 7 bits ‘1010101’ of the generated hash value ‘875EC87B380639D2B21A6D6D4457991938B146A55A052E60DED576B658713CD5’ match the heap authentication information ‘1000011(b63˜b57)’ and ‘0101010(b55˜b49)’ included in the accessed address, the access is allowed. Therefore, the heap in the physical memory is deallocated using the free( ) function, and heap deallocation information is set in the virtual memory area mapped to the physical memory.

The header area of the virtual memory (0x30001f83) is 1 byte and includes 7-bit previous heap authentication information (b7˜b1) and 1-bit access permission information (b0). The 1-bit access permission information (b0) in the header area of the virtual memory area is the access permission information for the heap header area that should not be accessed by the program (user), so access is blocked by maintaining the existing access permission information (‘b0=0’) that was set when the heap was allocated. Also, the 7-bit heap authentication information (b7˜b1) needs to be updated with the previous heap authentication information, in which case the previous heap authentication information is ‘1010101’ because it is the least significant 7 bits of the heap authentication information that was used when the heap was allocated. Therefore, the header area of the virtual memory is set to ‘10101010 (0xaa)’ by combining the 7-bit previous heap authentication information (b7˜b1=1010101) with the 1-bit access permission information (b0=0).

Because the heap size is ‘0x10’, the body area of the virtual memory (0x30001f84) is configured with 1 byte, and the heap offset thereof is ‘0x01’. The 1-byte body area of the virtual memory includes 7-bit heap size information (b7˜b1, a heap offset) and 1-bit access permission information (b0). The 1-bit access permission information (b0) is the access permission information for the heap body area, which is a data area used by the program (user), but the heap body area is deallocated, so access is blocked by setting the access permission information to ‘b0=0’. Also, the 7-bit heap size information (b7˜b1) is set to the heap offset (heap_offset) value defined in 16-byte increments based on the address of the header of the virtual memory, and after heap deallocation, the heap offset is set to ‘heap_offset=0’. Therefore, the body area of the virtual memory (0x30001f84) is set to ‘00000000 (0x00)’ by combining the 7-bit heap size information (b7˜b1=0000000) with the 1-bit access permission information (b0=0).

8) ptr1[15]=5; //Detect UAF

After checking the access permission information (b0) in the virtual memory area (0x30001f84) mapped to the accessed address (0x87aa0000_0001f840), because the access permission information is ‘b0=0’, the access is blocked, and the exception is handled, whereby UAF (Use After Free) is detected normally.

### 9) Free(ptr3);

After checking the access permission information (b0) in the virtual memory area (0x30001f88) mapped to the accessed address (0x29700000_0001f880), because the access permission information is ‘b0=1’, it is determined that access is allowed, the address of the header of the virtual memory is calculated by checking and using the heap offset (heap_offset), ‘0x01’, which is the heap size information stored in the body area of the virtual memory, and previous heap authentication information is obtained. Because the address of the header of the virtual memory is ‘0x30001f87’ (0x30001f88-0x01), the previous heap authentication information (prev_pac) stored at the address of the header of the virtual memory is ‘0xf6’. Therefore, the hash value to be used as heap authentication information is generated by inputting the start address of the body of the virtual memory mapped to the heap allocation address (0x30001f88), the value at the address of the body of the virtual memory (0x03, the heap size information), the address of the header of the virtual memory (0x30001f87), and the value of the header of the virtual memory (0xf6, the previous heap authentication information). Because the most significant 7 bits ‘0010100’ and the least significant 7 bits ‘0111000’ of the generated hash value ‘29235F9BC7AF1ED5B4B39398B1D383EF92C61CDB946509A01644BE0B066388B 8’ match the heap authentication information ‘0010100(b63˜b57)’ and ‘0111000(b55˜b49)’ included in the accessed address, the access is allowed. Therefore, the heap in the physical memory is deallocated through the free( ) function, and heap deallocation information is set in the virtual memory area mapped to the physical memory.

The header area of the virtual memory (0x30001f87) is 1 byte and includes 7-bit previous heap authentication information (b7˜b1) and 1-bit access permission information (b0). The 1-bit access permission information (b0) in the header area of the virtual memory is the access permission information for the heap header area that should not be accessed by the program (user), so access is blocked by maintaining the access permission information (‘b0=0’) that was set when the heap was allocated. Also, the 7-bit heap authentication information (b7˜b1) needs to be updated with the previous heap authentication information, in which case the previous heap authentication information is ‘0111000’ because it is the least significant 7 bits of the heap authentication information that was used when the heap was allocated. Therefore, the header area of the virtual memory is set to ‘01110000 (0x70)’ by combining the 7-bit previous heap authentication information (b7˜b1=0111000) with the 1-bit access permission information (b0=0).

Because the heap size is ‘0x10’, the body area of the virtual memory (0x30001f88) is configured with 1 byte, and the heap offset thereof is ‘0x01’. The 1-byte body area of the virtual memory includes 7-bits heap size information (b7˜b1, the heap offset) and 1-bit access permission information (b0). The 1-bit access permission information (b0) is the access permission information for the heap body area that is a data area used by the program (user), but because the heap body area is deallocated, access is blocked by setting the access permission information to ‘b0=0’. Also, the 7-bit heap size information (b7˜b1) is set to the heap offset (heap_offset) value defined in 16-byte increments based on the address of the header of the virtual memory, and after heap deallocation, the heap offset is set to ‘heap_offset=0’. Therefore, the body area of the virtual memory (0x30001f88) is set to ‘00000000 (0x00)’ by combining the 7-bit heap size information (b7˜b1=0000000) with the 1-bit access permission information (b0=0).

10) free(ptr3); //Try Double Free

After checking the access permission information (b0) in the virtual memory area (0x30001f88) mapped to the accessed address (0x29700000_0001f880), because the access permission information is ‘b0=0’, access is blocked, and the exception is handled, whereby DFB (Double Free Bug) is detected normally.

11) ptr4=malloc(0x10); //Reallocate in Area to which ptr3 Used to Point

When allocation of heap with a certain size is requested, if there is a recently deallocated heap area having the same size, heap is reallocated at the same physical address (0x00000000_0001f880). After reallocation, the virtual memory address mapped to the physical memory address is also the same as the virtual memory address (0x30001f88) of the deallocated heap area.

After heap reallocation, ‘0x00000000_0001f880’, which is the start address of the heap body area used as a data area, is returned to the program (user), and this address is the same as the physical address of ptr3, but in order to return a different address each time heap is allocated, not this address but ‘0x91540000_0001f880’ is returned as a new heap allocation address including the heap allocation information described in the present disclosure. The heap allocation address including the heap allocation information may use the previous heap authentication information that was updated when the heap was deallocated, and ‘01110000 (0x70)’, which is a combination of the 7-bit previous heap authentication information ‘0111000’ stored in the header of the virtual memory (0x30001f87) and the 1-bit access permission information, ‘0’, is used as the previous heap authentication information. Accordingly, the hash value to be used as heap authentication information is generated by inputting the start address of the body of the virtual memory mapped to the heap allocation address (0x30001f88), the value at the start address of the body of the virtual memory (0x03, the heap size information), the address of the header of the virtual memory (0x30001f87), and the value of the header of the virtual memory (0x70, the previous heap authentication information). The bits b63˜b56 of the heap allocation address are configured with ‘10010001 (0x91)’ by combining the most significant 7 bits (1001000) of the generated hash value ‘903F6F54BB0B6E5C2488CFE486E9C51BACA9E175310114A47FCDFC314C9D442 A’ and 1-bit heap allocation address identification information (1, indicating that the address is a heap allocation address), the bits b55˜b48 of the heap allocation address are configured with ‘01010100 (0x54)’ by combining the least significant 7 bits (0101010) of the hash value and 1-bit heap size information (0, indicating a heap size less than 0x800), and the bits b47˜b0 of the heap allocation address are configured with the 48-bit address (0x0000_0001f880), whereby ‘0x91540000_0001f880’ is generated as a new heap allocation address including the heap allocation information and is returned to the program (user).

The header area of the virtual memory (0x30001f87) is configured with 1 byte, which includes the least significant 7 bits of the previous heap authentication information and the access permission information set to ‘b0=0’ for the heap header to block access. When the heap is reallocated, the header area of the virtual memory that was set when the heap was deallocated is maintained. Accordingly, the header area of the virtual memory retains the value set to ‘01110000 (0x70)’ by combining the existing 7-bit previous heap authentication information (b7˜b1=0111000) and the 1-bit access permission information (b0=0).

Because the heap size is ‘0x10’, the body area of the virtual memory (0x30001f88) is configured with 1 byte, and the heap offset thereof is ‘0x01’. Accordingly, the body area of the virtual memory includes the 7-bit heap offset (b7˜b1) and the 1-bit access permission information set to ‘b0=1’ for the heap body to allow access. Therefore, the body area of the virtual memory is set to ‘00000011 (0x03)’ by combining the 7-bit heap offset (0000001) and the 1-bit access permission information (1) for the heap body.

12) ptr3=5; //Detect UAF

After checking the access permission information (b0) in the virtual memory area (0x30001f88) mapped to the accessed address (0x29700000_0001f880), because the access permission information is ‘b0=1’, it is determined that access is allowed, the address of the header of the virtual memory is calculated by checking and using the heap offset (heap_offset), ‘0x01’, which is the heap size information stored in the body area of the virtual memory, and previous heap authentication information is obtained. Because the address of the header of the virtual memory is ‘0x30001f87’ (0x30001f88-0x01), the previous heap authentication information (prev_pac) stored at the address of the header of the virtual memory is ‘0x70’. Accordingly, the hash value to be used as heap authentication information is generated by inputting the start address of the body of the virtual memory mapped to the heap allocation address (0x30001f88), the value at the start address of the body of the virtual memory (0x03, the heap size information), the address of the header of the virtual memory (0x30001f87), and the value of the header of the virtual memory (0x70, the previous heap authentication information). Because the most significant 7 bits ‘1001000’ and the least significant 7 bits ‘0101010’ of the generated hash value ‘903F6F54BB0B6E5C2488CFE486E9C51BACA9E175310114A47FCDFC314C9D442 A’ do not match the heap authentication information ‘0010100(b63˜b57)’ and ‘0111000(b55˜b49)’ included in the accessed address, the access is blocked, and the exception is handled, whereby UAF (Use After Free) is detected normally.

13) free(ptr2); //No Merging with ptr1

After checking the access permission information (b0) in the virtual memory area (0x30001f86) mapped to the accessed address (0x95fc0000_0001f860), because the access permission information ‘b0=1’, it is determined that the access is allowed, the address of the header of the virtual memory is calculated by checking and using the heap offset (heap_offset) ‘0x01’, which is the heap size information stored in the body area of the virtual memory, and previous heap authentication information is obtained. Because the address of the header of the virtual memory is ‘0x30001f85’ (0x30001f86-0x01), the previous heap authentication information (prev_pac) stored at the address of the header of the virtual memory is ‘0xc4’. Accordingly, the hash value to be used as heap authentication information is generated by inputting the start address of the body of the virtual memory mapped to the heap allocation address (0x30001f86), the value at the start address of the body of the virtual memory (0x03, the heap size information), the address of the header of the virtual memory (0x30001f85), and the value of the header of the virtual memory (0xc4, the previous heap authentication information). Because the most significant 7 bits ‘1001010’ and the least significant 7 bits ‘1111111’ of the generated hash value ‘9423F8312BACFFF6CD855BF758A37F179C2BE69AA4FACB698980E5904A93247 F’ match the heap authentication information ‘1001010(b63˜b57)’ and ‘1111111(b55˜b49)’ included in the accessed address, the access is allowed. Therefore, the heap in the physical memory is deallocated using the free( ) function, and heap deallocation information is set in the virtual memory area mapped to the physical memory.

The header area of the virtual memory (0x30001f85) is 1 byte and includes 7-bit previous heap authentication information (b7˜b1) and 1-bit access permission information (b0). The 1-bit access permission information (b0) in the header area of the virtual memory is the access permission information for the heap header area that should not be accessed by the program (user), access is blocked by maintaining the access permission information (‘b0=0’) that was set when the heap was allocated. Also, the 7-bit heap authentication information (b7˜b1) needs to be updated with the previous heap authentication information, in which case the previous heap authentication information is ‘1111111’ that is the least significant 7 bits of the heap authentication information that was used when the heap was allocated. Accordingly, the header area of the virtual memory is set to ‘11111110 (0xfe)’ by combining the 7-bit previous heap authentication information (b7˜b1=1111111) and the 1-bit access permission information (b0=0).

Because the heap size is ‘0x10’, the body area of the virtual memory (0x30001f86) is configured with 1 byte and the heap offset thereof is ‘0x01’. The 1-byte body area of the virtual memory includes 7-bit heap size information (b7˜b1, the heap offset) and 1-bit access permission information (b0). The 1-bit access permission information (b0) is the access permission information for the heap body area, which is a data area used by the program (user), but the heap body area is deallocated, so the access permission information is set to ‘b0=0’ to block access. Also, the 7-bit heap size information (b7˜b1) is set to a heap offset (heap_offset) value defined in 16-byte increments based on the address of the header of the virtual memory, and after heap deallocation, the heap offset is set to ‘heap_offset=0’. Therefore, the body area of the virtual memory (0x30001f86) is set to ‘00000000 (0x00)’ by combining the 7-bit heap size information (b7˜b1=0000000) and the 1-bit access permission information (b0=0).

14) ptr2=5; //Detect UAF

After checking the access permission information (b0) in the virtual memory area (0x30001f86) mapped to the accessed address (0x95fc0000_0001f860), because the access permission information is ‘b0=0’, the access is blocked, and the exception is handled, whereby UAF (Use After Free) is detected normally.

15) ptr5=malloc(0x10); //Reallocate Area to which ptr2 Used to Point

When heap with the same size as a recently deallocated heap area is requested, heap is reallocated at the same physical address (0x00000000_0001f860). After the reallocation, the virtual memory address mapped to the physical address is also the same as the virtual memory address (0x30001f86) of the recently deallocated heap area.

After the heap is reallocated, ‘0x00000000_0001f860’, which is the start address of the heap body area used as a data area, is returned to the program (user), and this address is the same as the physical address of ptr2, but in order to return a different address each time heap is allocated, not this address but ‘0x67ee0000_0001f860’ is returned as a new heap allocation address by adding the heap allocation information described in the present disclosure. The heap allocation address including the heap allocation information may use the previous heap authentication information that was updated when the heap was deallocated, in which case ‘11111110 (0xfe)’, which is a combination of the 7-bit previous heap authentication information ‘1111111’ and the 1-bit access permission information ‘0’ stored in the header of the virtual memory (0x30001f85), is used as the previous heap authentication information. Therefore, the hash value to be used as heap authentication information is generated by inputting the start address of the body of the virtual memory mapped to the heap allocation address (0x30001f86), the value at the address of the body of the virtual memory (0x03, the heap size information), the address of the header of the virtual memory (0x30001f85), and the value of the header of the virtual memory (0xfe, the previous heap authentication information). The bits from b63˜b56 of the heap allocation address are configured with ‘01100111 (0x67)’ by combining the most significant 7 bits (0110011) of the generated hash value ‘67B22E23EE202B7E56850412DF82EE34B0E5FD065975F64C72C3D26E096FB477’ with 1-bit heap allocation address identification information (1, indicating that the address is a heap allocation address), the bits b55˜b48 of the heap allocation address are configured with ‘11101110 (0xce)’ by combining the least significant 7 bits (1110111) of the hash value with 1-bit heap size information (0, indicating a heap size less than 0x800), and the bits b47˜b0 of the heap allocation address are configured with the 48-bit address (0x00000000_0001f860), whereby ‘0x67ee0000_0001f860’ is generated as a new heap allocation address including the heap allocation information and is returned to the program (user).

The header area of the virtual memory (0x30001f85) is configured with 1 byte, which includes the least significant 7 bits of the previous heap authentication information and access permission information set to ‘b0=0’ for the heap header to block access. When heap is reallocated, the header area of the virtual memory that was set when heap was deallocated is maintained. Therefore, the header area of the virtual memory retains the value set to ‘11111110 (0xfe)’ by combining the existing 7-bit previous heap authentication information (b7˜b1=1111111) and the 1-bit access permission information (b0=0).

Because the heap size is ‘0x10’, the body area of the virtual memory (0x30001f86) is configured with 1 byte, and the heap offset thereof is ‘0x01’. Accordingly, the body area of the virtual memory includes the 7-bit heap offset (b7˜b1) and the 1-bit access permission information set to ‘b0=1’ for the heap body to allow access. Therefore, the body area of the virtual memory is set to ‘00000011 (0x03)’ by combining the 7-bit heap offset (0000001) and the 1-bit access permission information (1) for the heap body.

16) ptr2=5; //Detect UAF

After checking the access permission information (b0) in the virtual memory area (0x30001f86), mapped to the accessed address (0x95fe0000_0001f860), because the access permission information is ‘b0=1’, it is determined that the access is allowed, the address of the header of the virtual memory is calculated by checking and using the heap offset (heap_offset) ‘0x01’, which is the heap size information stored in the body area of the virtual memory, and previous heap authentication information is obtained. Because the address of the header of the virtual memory is ‘0x30001f85’ (0x30001f86-0x01), the previous heap authentication information (prev_pac) stored at the address of the header of the virtual memory is ‘0xfe’. Accordingly, the hash value to be used as heap authentication information is generated by inputting the start address of body of the virtual memory mapped to the heap allocation address (0x30001f86), the value at the start address of the body of the virtual memory (0x03, the heap size information), the address of the header of the virtual memory (0x30001f85), and the value of the header of the virtual memory (0xfe, the previous heap authentication information). Because the most significant 7 bits ‘0110011’ and the least significant 7 bits ‘1110111’ of the generated hash value ‘67B22E23EE202B7E56850412DF82EE34B0E5FD065975F64C72C3D26E096FB477’ do not match the heap authentication information ‘1001010(b63˜b57)’ and ‘1111111(b55˜b49)’ included in the accessed address, the access is blocked, and the exception is handled, whereby UAF (Use After Free) is detected normally.

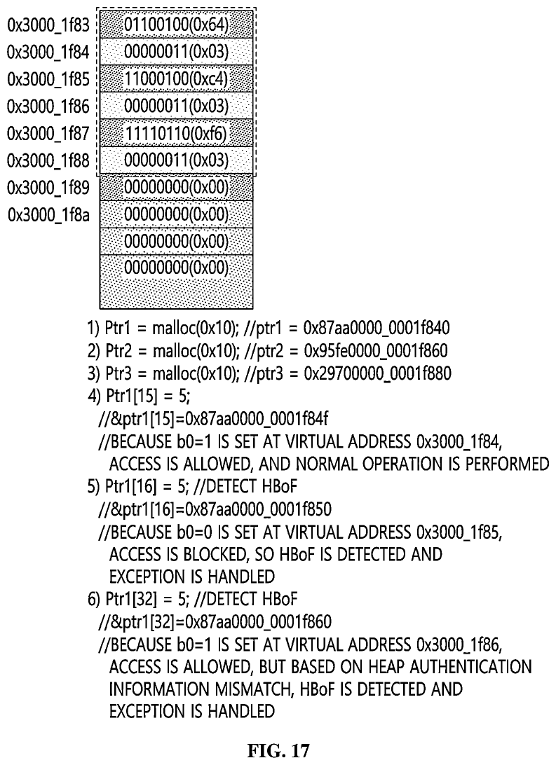

FIGS. 17 to 22 are views for explaining a method for detecting a vulnerability according to another embodiment of the present disclosure.

FIGS. 17 to 22 are another embodiment according to the present disclosure for accomplishing the above objects and show an embodiment for the case in which three dynamic memory areas having the same size are allocated, access within the range of the allocated memory area is made, access out of the range of the allocated memory area is made, access to a deallocated memory area is made after deallocation of the allocated dynamic memory, deallocation is attempted again after deallocation of the allocated dynamic memory, and access to a reallocated dynamic memory area is made with a previous pointer (address) after reallocation in the deallocated dynamic memory area, similar to the program of Table 2.

The embodiment described below is different from the embodiment in Table 2 in that, when a heap area is allocated and deallocated, if a deallocated heap area adjacent thereto is present, merging therewith is performed, and when a heap area is reallocated, the first deallocated heap area is used. First, like Table 2, Table 3 is an embodiment of a program that allocates three dynamic memory areas with the same heap size 16 (0x10) bytes and tests for detection of Heap-based Buffer OverFlow (HBOF), Use After Free (UAF), and Double Free Bug (DFB).

TABLE 3
1) ptr1 = malloc(0x10);
2) ptr2 = malloc(0x10);
3) ptr3 = malloc(0x10);
4) ptr1[15] = 5; //access within heap area range
5) ptr1[16] = 5; //access out of heap area range (detect HboF)
6) ptr1[32] = 5; // access out of heap area range (detect HboF)
7) free(ptr1);
8) ptr1[15] = 5; //detect UAF
9) free(ptr3);
10) free(ptr3); //attempt Double Free
11) ptr4 = malloc(0x10); //reallocate in area to which ptr1 used to point
12) ptr1 = 5; //detect UAF
13) free(ptr2); // merge with ptr3
14) ptr2 = 5; //detect UAF
15) ptr5 = malloc(0x10); // reallocate in area to which ptr2 used to point
16) ptr2 = 5; //detect UAF

FIGS. 17 to 22 show an embodiment of a new heap allocation address including heap allocation information that is returned to a program (user) after heap allocation, a virtual memory address mapped to physical memory, and heap allocation information stored in the header and body of a virtual memory area when the program of Table 3 is executed. Therefore, the embodiment based on execution of the program in Table 3 is described as follows. Here, the result of execution of the lines indicated by ‘1)˜10)’ and ‘14)˜16)’ in the program of Table 3 is the same as the result of execution of the lines indicated by ‘1)˜10)’ and ‘14)˜16)’ in the program of Table 2, thus a description is made based on execution of the lines indicated by 11)˜13) in the program of Table 3.

$$ptr 1 = malloc ( 0 \times 10 ) ; \qquad 1 )$$

$$ptr 2 = malloc ( 0 \times 10 ) ; \qquad 2 )$$

$$ptr 3 = malloc ( 0 \times 10 ) ; \qquad 3 )$$

$$ptr 1 [ 15 ] = 5 ; // access within heap area range \qquad 4 )$$

$$ptr 1 [ 16 ] = 5 ; // access out of heap area range ( detect HBoF ) \qquad 5 )$$

$$ptr 1 [ 32 ] = 5 ; // access out of heap area range ( detect HBoF ) \qquad 6 )$$

$$free ( prt 1 ) ; \qquad 7 )$$

$$ptr 1 [ 15 ] = 5 ; // detect UAF \qquad 8 )$$

$$free ( prt 3 ) ; \qquad 9 )$$

$$free ( ptr 3 ) ; // attempt Double Free \qquad 10 )$$

$$ptr 4 = malloc ( 0 \times 10 ) ; \text{} // reallocate in area to which ptr 1 used to point \qquad 11 )$$

When heap is requested, if deallocated heap areas having the same size as the requested heap are present, heap is allocated at the same physical address as the first deallocated heap area (ptr1) (0x00000000_0001f840) according to the order in which the heap areas were deallocated. After the reallocation, the virtual memory address mapped to the physical memory address is also the same as the virtual memory address (0x30001f84) of the first deallocated heap area.

After the heap reallocation, ‘0x00000000_0001f840’, which is the start address of the heap body area used as a data area, is returned to the program (user), and this address is the same as the physical address of ptr1, but in order to return a different address each time heap is allocated, not this address but ‘0x4dfe0000_0001f840’ is returned as a new heap allocation address by including the heap allocation information described in the present disclosure. The heap allocation address including the heap allocation information may use the previous heap authentication information that was updated when heap was deallocated, in which case ‘10101010 (0xaa)’, which is a combination of the 7-bit previous heap authentication information ‘1010101’ and the 1-bit access permission information ‘0’ stored in the header of the virtual memory (0x30001f83), is used as the previous heap authentication information. Therefore, the hash value to be used as heap authentication information is generated by inputting the start address of the body of the virtual memory mapped to the address of the allocated heap (0x30001f84), the value at the start address of the body of the virtual memory (0x03, the heap size information), the address of the header of the virtual memory (0x30001f83), and the value of the header of the virtual memory (0xaa, the previous heap authentication information). The bits b63˜b56 of the heap allocation address are configured with ‘01001101 (0x4d)’ by combining the most significant 7 bits (0100110) the generated hash value of ‘4C3185BF7808FD37EB4D515BE33C0A76C7117B8C1329881A8F4741B5E8EF37FF’ and 1-bit heap allocation address identification information (1, indicating that the address is a heap allocation address), the bits b55˜b48 of the heap allocation address are configured with ‘11111110 (0xfe)’ by combining the least significant 7 bits (1111111) of the hash value and 1-bit heap size information (0, indicating a heap size less than 0x800), and the bits b47˜b0 of the heap allocation address are configured with the 48-bit address (0x00000000_0001f840), whereby ‘0x4dfe0000_0001f840’ is generated as a new heap allocation address including the heap allocation information and is returned to the program (user).

The header area of the virtual memory (0x30001f83) is configured with 1 byte, which includes the least significant 7 bits of the previous heap authentication information and the access permission information set to ‘b0=0’ for the heap header to block access. When heap is reallocated, the header area of the virtual memory that was set when the heap was deallocated is maintained. Accordingly, the header area of the virtual memory maintains the existing value set to ‘11111110 (0xfe)’ by combining the existing 7-bit previous heap authentication information (b7˜b1=1111111) and the 1-bit access permission information (b0=0).

Because the heap size is ‘0x10’, the body area of the virtual memory (0x30001f84) is configured with 1 byte, and the heap offset thereof is ‘0x01’. Therefore, the body area of the virtual memory includes the 7-bit heap offset (b7˜b1=0000001) and the 1-bit access permission information set to ‘b0=1’ for the heap body to allow access. Therefore, the body area of the virtual memory is set to ‘00000011 (0x03)’ by combining the 7-bit heap offset (0000001) and the 1-bit access permission information (1) for the heap body.

$$ptr 1 = 5 ; // detect UAF \qquad 12 )$$

After checking the access permission information (b0) in the virtual memory area (0x30001f84) mapped to the accessed address (0x87aa0000_0001f840), because the access permission information is ‘b0=1’, it is determined that the access is allowed, the address of the header of the virtual memory is calculated by checking and using the heap offset (heap_offset) ‘0x01’, which is the heap size information stored in the body area of the virtual memory, and previous heap authentication information is obtained. Because the address of the header of the virtual memory is ‘0x30001f83’ (0x30001f84-0x01), the previous heap authentication information (prev_pac) stored at the address of the header of the virtual memory is ‘0xaa’. Therefore, the hash value to be used as heap authentication information is generated by inputting the start address of the body of the virtual memory mapped to the address of the allocated heap (0x30001f84), the value at the start address of the body of the virtual memory (0x03, the heap size information), the address of the header of the virtual memory (0x30001f83), and the value of the header of the virtual memory (0xaa, the previous heap authentication information). Because the most significant 7 bits ‘0100110’ and the least significant 7 bits ‘1111111’ of the generated hash value ‘4C3185BF7808FD37EB4D515BE33C0A76C7117B8C1329881A8F4741B5E8EF37FF’ do not match the heap authentication information ‘0100110(b63˜b57)’ and ‘1111111(b55˜b49)’ included in the accessed address, the access is blocked, and the exception is handled, whereby UAF (Use After Free) is detected normally.

$$free ( prt 2 ) ; // merge with ptr 3 \qquad 13 )$$

After checking the access permission information (b0) in the virtual memory area (0x30001f86) mapped to the accessed address (0x95fe0000_0001f860), because the access permission information is ‘b0=1’, it is determined that the access is allowed, the address of the header of the virtual memory is calculated by checking and using the heap offset (heap_offset) ‘0x01’, which is the heap size information stored at the address of the body of the virtual memory, and previous heap authentication information is obtained. Because the address of the header of the virtual memory is ‘0x30001f85’ (0x30001f86-0x01), the previous heap authentication (prev_pac) stored at the address of the header of the virtual memory is ‘0xc4’. Therefore, the hash value to be used as heap authentication information is generated by inputting the start address of the body of the virtual memory mapped to the heap allocation address (0x30001f86), the value at the start address of the body of the virtual memory (0x03, the heap size information), the address of the header of the virtual memory (0x30001f85), and the value of the header of the virtual memory (0xc4, the previous heap authentication information). Because the most significant 7 bits ‘1001010’ and the least significant 7 bits ‘1111111’ of the generated hash value ‘9423F8312BACFFF6CD855BF758A37F179C2BE69AA4FACB698980E5904A93247 F’ match the heap authentication information ‘1001010(b63˜b57)’ and ‘1111111(b55˜b49)’ included in the accessed address, the access is allowed. Therefore, the heap in the physical memory is deallocated using the free( ) function, and heap deallocation information is set in the virtual memory area mapped to the physical memory. Here, because a deallocated heap area (ptr3) adjacent to the deallocated heap is present, the deallocated heap is merged with the deallocated heap area adjacent thereto.

The header area of the virtual memory (0x30001f85) is 1 byte and includes 7-bit previous heap authentication information (b7˜b1) and 1-bit access permission information (b0). Because the 1-bit access permission information (b0) in the header area of the virtual memory area is the access permission information for the heap header area that should not be accessed by the program (user), the access permission information (‘b0=0’) that was set when the heap was allocated is maintained to block access. Also, the 7-bit heap authentication information (b7˜b1) needs to be updated with the previous heap authentication information, in which case the previous heap authentication information is ‘1111111’ that is the least significant 7 bits of the heap authentication information that was used when the heap was allocated. Therefore, the header area of the virtual memory is set to ‘11111110 (0xfe)’ by combining the 7-bit previous heap authentication information (b7˜b1=1111111) and the 1-bit access permission information (b0=0).

Because the heap size is ‘0x10’, the body area of the virtual memory (0x30001f86) is configured with 1 byte, and the heap offset thereof is ‘0x01’. The 1-byte body area of the virtual memory includes 7-bit heap size information (b7˜b1, the heap offset) and 1-bit access permission information (b0). The 1-bit access permission information (b0) is the access permission information for the heap body area, which is a data area used by the program (user), but because the heap body area is deallocated, the access permission information is to ‘b0=0’ to block access. Also, the 7-bit heap size information (b7˜b1) is set to a heap offset (heap_offset) value defined in 16-byte increments based on the address of the header of the virtual memory, and after the heap deallocation, the heap offset is set to ‘heap_offset=0’. Therefore, the body area of the virtual memory (0x30001f86) is set to ‘00000000 (0x00)’ by combining the 7-bit heap size information (b7˜b1=0000000) and the 1-bit access permission information (b0=0). Here, although the deallocated heap area is merged with the adjacent deallocated heap area (ptr3), the existing value set in the header area of the virtual memory for the deallocated heap area is maintained. In other words, when the header area of the virtual memory of the deallocated heap area is reallocated, the value set in the header area of the virtual memory is used as the previous heap authentication information.

$$ptr 2 = 5 ; // detect UAF \qquad 14 )$$

$$ptr 5 = malloc ( 0 \times 10 ) ; \text{} // reallocate area to which ptr 2 used to point \qquad 15 )$$

$$ptr 2 = 5 ; // detect UAF \qquad 16 )$$

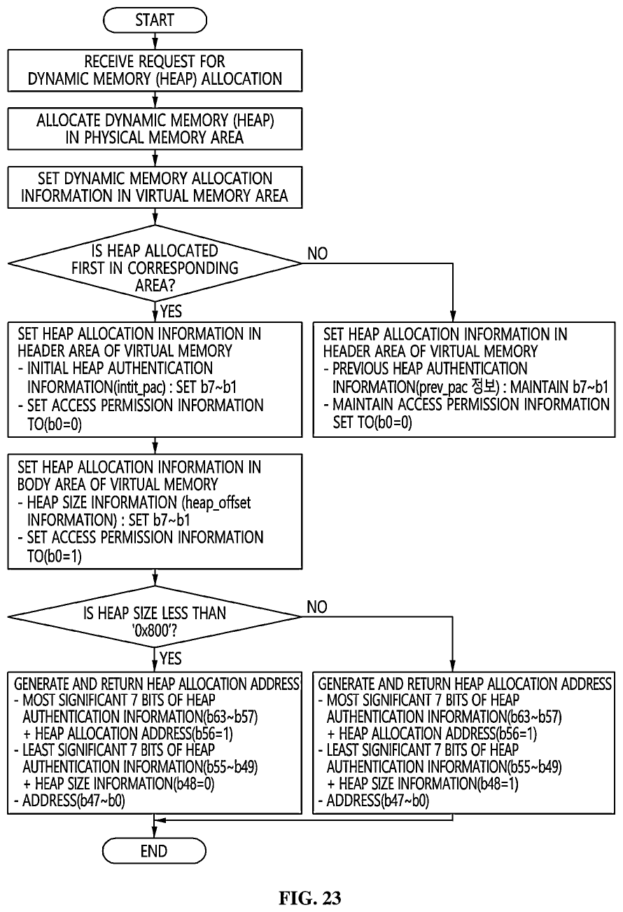

FIG. 23 is a flowchart illustrating a process of setting heap allocation information when dynamic memory is allocated in a method according to an embodiment of the present disclosure.

Referring to FIG. 23, a process of setting heap allocation information in a heap area of virtual memory mapped to a physical memory address and setting heap allocation information (heap authentication information, heap allocation address identification information, and heap size information) included in the address returned to a program (user) when heap is allocated in physical memory in response to a heap allocation request from the program (user) is illustrated. In response to a request for dynamic memory (heap) allocation, dynamic memory is allocated in the physical memory area, and heap allocation information is set in the virtual memory mapped to the allocated dynamic memory.

When a corresponding heap area is allocated first, heap allocation information in the header area of virtual memory is set by setting a 7-bit arbitrary value (a randomly generated value) as initial authentication information and setting 1-bit access permission information (b0) to ‘b0=1’ to block access to a heap header area, as described in FIG. 2. However, when the corresponding heap area is reallocated, because heap authentication information has been updated with 7-bit previous heap authentication information (b7˜b1) when the heap was deallocated, as described in FIGS. 7 and 8, the existing previous heap authentication information is maintained. The 1-bit access permission information is the access permission information for the heap header area that should not be accessed by the program (user), so the value set to ‘b0=0’ is maintained to block access to the heap header area. That is, when the corresponding heap area is reallocated, the heap allocation information in the header area of the virtual memory is maintained without change.

Heap allocation information in the body area of the virtual memory is set by setting 1-bit access permission information to ‘b0=1’ to allow access because it is the access permission information for a heap body area, as described in FIG. 3, and by setting 7-bit heap size information, which is an offset value based on the address of the header of the virtual memory, to a heap offset (heap_offset) value defined in 16-byte increments. When setting the heap allocation information in the virtual memory area is completed as described above, a heap address for the heap area allocated to the program (user) is generated and returned. Here, in the case of the heap allocation address, the bits b63˜b56 thereof are set to a combination of the most significant 7 bits of a hash value, which is calculated by inputting the heap allocation information (the address of the header of the virtual memory, the heap size information, the previous heap authentication information (initial authentication information), and the address of the body of the virtual memory), and 1-bit heap allocation address identification information (b56=1, set to ‘1’ to indicate that the address is a heap allocation address), the bits b57˜b48 of the address are set to a combination of the least significant 7 bits of the hash value and 1-bit heap size information (b48, set to ‘1’ if the heap size is equal to or greater than 0x800, but set to ‘0’ if it is less than 0x800), and the bits b47˜b0 thereof are set to the address, whereby a new heap allocation address including the heap allocation information is generated and returned, as described in FIGS. 3 and 4.

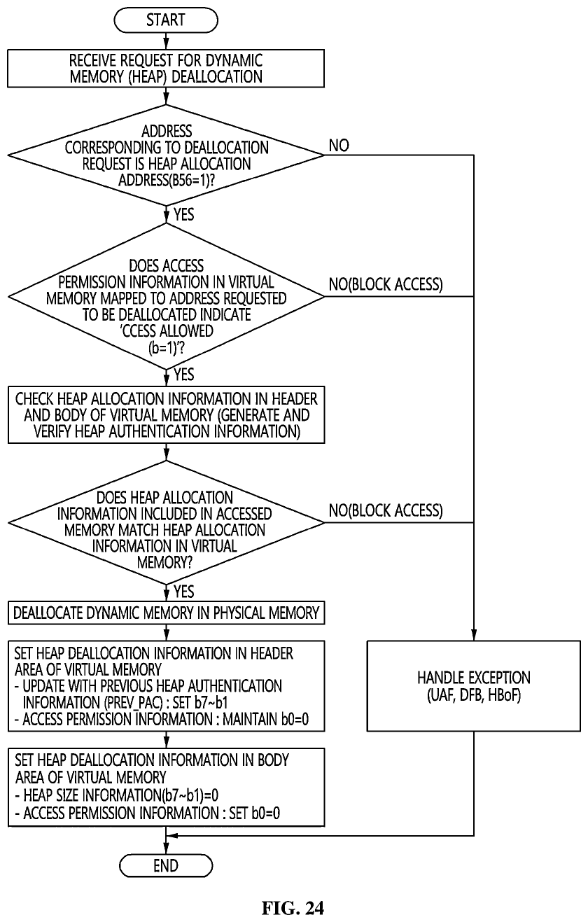

FIG. 24 is a flowchart illustrating a process of setting heap deallocation information when dynamic memory is deallocated in a method according to an embodiment of the present disclosure.

FIG. 24 shows a process of setting heap deallocation information in a virtual memory area mapped to a physical memory address after heap in physical memory is deallocated in response to a heap deallocation request from a program (user). In response to a request to deallocate dynamic memory (heap), whether the heap at the accessed address can be deallocated is checked. First, whether the address of the heap requested to be deallocated is an address at which heap is allocated (b56=1) is checked, and if the bit b56 is 0 (‘b56=0’), exception handling is performed because it is the access to an invalid address, but if the bit b56 is 1 (‘b56=1’), the address is an address at which heap is allocated, so the access permission information in the virtual memory area mapped to the address is checked.

If the access permission information is ‘b0=0’, this indicates that the access is blocked, so exception handling is performed. However, if the access permission information is ‘b0=1’, heap authentication information is generated using the heap allocation information in the header and body of the virtual memory described in FIG. 3 and is verified by comparing the same with the heap authentication information included in the address. If the generated heap authentication information and the heap authentication information included in the address do not match, exception handling is performed, but if they match each other, it is determined that heap deallocation is possible, so the heap in the physical memory area is deallocated. When deallocation of the heap in the physical memory area is completed, heap deallocation information is set in the virtual memory area mapped to the physical memory area. First, the heap deallocation information in the header area of the virtual memory is set by maintaining 1-bit access permission information (b0) set to ‘b0=0’, which was set when the heap was allocated, to block access because the access permission information is the access permission information for the heap header area that should not be accessed by the program (user), and by setting 7-bit heap authentication information (b7˜b1) by updating the same with previous heap authentication information, as described in FIG. 5.

Also, the heap deallocation information in the body area of the virtual memory is set by setting 1-bit access permission information (b0) to ‘b0=0’ for the deallocated heap area to block access and setting 7-bit heap size information (b7˜b1) to ‘heap_offset=0’, as described in FIG. 5, and the heap deallocation is terminated.

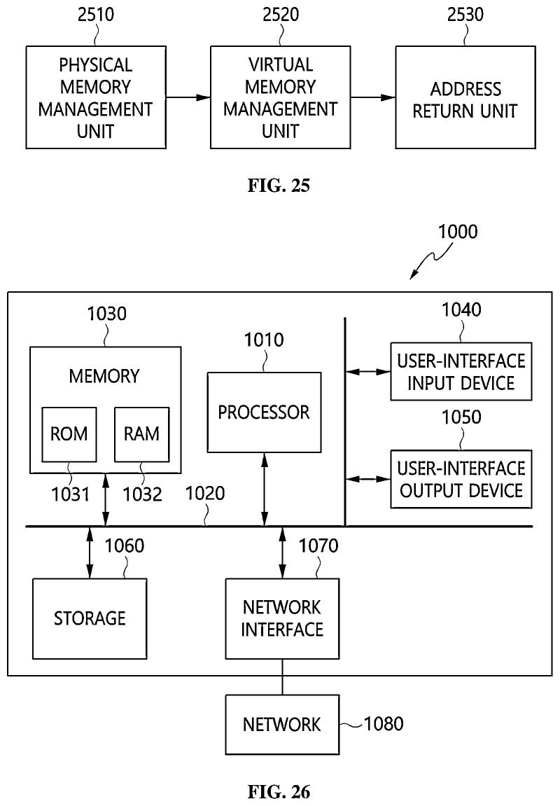

FIG. 25 is a block diagram illustrating an apparatus for detecting a security vulnerability of dynamic memory according to an embodiment of the present disclosure.

Referring to FIG. 25, the apparatus for detecting a security vulnerability of dynamic memory according to an embodiment of the present disclosure includes a physical memory management unit 2510 for allocating a heap area in physical memory in response to a heap allocation request from a user, a virtual memory management unit 2520 for allocating a heap area of virtual memory corresponding to the heap area in the physical memory, and an address return unit 2530 for returning a heap allocation address to the user, and the heap allocation address includes heap authentication information, heap allocation address identification information, and heap size information.

Here, the heap area may include a heap header area and a heap body area.

Here, the heap allocation address may include the start address of the heap body area allocated in the physical memory.

Here, the heap authentication information may include the most significant 7 bits and the least significant 7 bits of a hash value generated based on previous heap authentication information, the heap size information, and a heap-allocation virtual address.

Here, the heap header area of the virtual memory indicates the previous heap authentication information and access permission information, the heap body area of the virtual memory indicates the heap size information and access permission information, and the heap size information in the heap body area may correspond to a heap offset (heap_offset) value defined in 16-byte increments.

Here, the heap size information may correspond to 1-bit information that indicates 1 when the size of the allocated heap area is greater than a preset size and indicates 0 when the size of the allocated heap area is equal to or less than the preset size.

Here, when access to the heap area in the physical memory occurs, the physical memory management unit may check the access permission information in the virtual memory corresponding to the physical memory and block the access depending on the access permission information.

Here, when access to the heap area of the physical memory occurs, the virtual memory management unit calculates the address of the header area of the virtual memory using the heap size information in the virtual memory. If the heap size information is 7 bits (b7˜b1) at the calculated address and corresponds to ‘0000000’, the virtual memory management unit determines that the address is not the header area of the virtual memory, so it may again calculate the address of the header area of the virtual memory based on a multiple of ‘0x80’.

FIG. 26 is a view illustrating the configuration of a computer system according to an embodiment.

The apparatus for detecting a security vulnerability of dynamic memory according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the configuration of the present disclosure, a virtual memory area that is physically separate from physical memory is additionally used for secure dynamic memory management, but because the size thereof is 1/16 the size of the physical memory, the memory overhead is minimized, whereby there is an effect of providing an efficient and secure dynamic-memory management function.

Also, according to the configuration of the present disclosure, after dynamic memory is allocated and deallocated, when the deallocated memory area is accessed, the security vulnerability may be detected more quickly by using 1 bit of access permission information in a virtual memory area.

Also, according to the configuration of the present disclosure, each time heap is allocated, a different address is returned as a heap allocation address. Therefore, even when a deallocated area is reallocated after allocation and deallocation of dynamic memory, a different address is returned, and because heap authentication information is included in the address, even when access is allowed based on the access permission, the heap authentication information is additionally compared and verified, whereby more powerful dynamic memory management is possible.

Also, according to the configuration of the present disclosure, because previous heap authentication information and a virtual memory address mapped to physical memory in which heap is allocated are used to generate heap authentication information, more secure heap authentication information may be generated, and prediction or reuse of the heap authentication information by attackers may be prevented.

Also, according to the configuration of the present disclosure, although heap authentication information configured with a limited number of bits is used, the heap authentication information is generated more securely and efficiently by utilizing previous heap authentication information and heap size information in virtual memory. Therefore, a more secure dynamic memory management function may be provided.

According to the present disclosure, a Use-After-Free (UAF) vulnerability in dynamic memory allocation may be effectively detected.

Also, the present disclosure may effectively detect Double Free Bug (DFB) that occurs when a deallocated heap area is deallocated again.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for detecting a security vulnerability of dynamic memory, comprising:
allocating a heap area in physical memory in response to a heap allocation request from a user;
allocating a heap area of virtual memory corresponding to the heap area in the physical memory; and
returning a heap allocation address to the user,
wherein the heap allocation address includes heap authentication information, heap allocation address identification information, and heap size information.

2. The method of claim 1, wherein the heap area includes a heap header area and a heap body area.

3. The method of claim 2, wherein the heap allocation address includes a start address of the heap body area allocated in the physical memory.

4. The method of claim 1, wherein the heap authentication information includes most significant 7 bits and least significant 7 bits of a hash value generated based on previous heap authentication information, the heap size information, and a heap-allocation virtual address.

5. The method of claim 2, wherein
a heap header area of the virtual memory indicates previous heap authentication information and access permission information,
a heap body area of the virtual memory indicates the heap size information and access permission information, and
the heap size information in the heap body area corresponds to a heap offset (heap_offset) value defined in 16-byte increments.

6. The method of claim 4, wherein the heap size information corresponds to 1-bit information that indicates 1 when a size of the allocated heap area is greater than a preset size and that indicates 0 when the size of the allocated heap area is equal to or less than the preset size.

7. The method of claim 1, wherein, when access to the heap area in the physical memory occurs, access permission information in the virtual memory corresponding to the physical memory is checked, and the access is blocked based on the access permission information.

8. The method of claim 7, wherein
when access to the heap area in the physical memory occurs, an address of a header area of the virtual memory is calculated using heap size information in the virtual memory, and
when the heap size information is 7 bits (b7˜b1) at the calculated address and corresponds to ‘0000000’, it is determined that the address is not the header area of the virtual memory, and the address of the header area of the virtual memory is calculated again based on a multiple of ‘0x80’.

9. The method of claim 1, further comprising:
setting heap deallocation information in response to a heap deallocation request from the user,
wherein setting the heap deallocation information comprises filling first 8 bytes of a heap body area of the physical memory corresponding to the heap deallocation request with a forward deallocated heap address, filling second 8 bytes of the heap body area of the physical memory corresponding to the heap deallocation request with a backward deallocated heap address, and initializing a remaining heap body area to 0.

10. The method of claim 9, wherein setting the heap deallocation information comprises updating a header area of the virtual memory corresponding to the heap deallocation request with previous heap authentication information and changing access permission information in a body area of the virtual memory corresponding to the heap deallocation request to 0.

11. The method of claim 9, further comprising:
after heap deallocation, reallocating a heap area in response to a heap reallocation request from the user,
wherein reallocating the heap area includes
reallocating the heap area in the physical memory,
updating heap area reallocation information in virtual memory corresponding to the reallocated physical memory, and
returning a heap reallocation address to the user.

12. The method of claim 11, wherein updating the heap area reallocation information in the virtual memory comprises maintaining previous heap authentication information in a heap header area of the virtual memory and updating a heap body area of the virtual memory.

13. An apparatus for detecting a security vulnerability of dynamic memory, comprising:
a physical memory management unit for allocating a heap area in physical memory in response to a heap allocation request from a user;
a virtual memory management unit for allocating a heap area of virtual memory corresponding to the heap area in the physical memory; and
an address return unit for returning a heap allocation address to the user,
wherein the heap allocation address includes heap authentication information, heap allocation address identification information, and heap size information.

14. The apparatus of claim 13, wherein the heap area includes a heap header area and a heap body area.

15. The apparatus of claim 14, wherein the heap allocation address includes a start address of the heap body area allocated in the physical memory.

16. The apparatus of claim 13, wherein the heap authentication information includes most significant 7 bits and least significant 7 bits of a hash value generated based on previous heap authentication information, the heap size information, and a heap-allocation virtual address.

17. The apparatus of claim 14, wherein
a heap header area of the virtual memory indicates previous heap authentication information and access permission information,
a heap body area of the virtual memory indicates heap size information and access permission information, and
the heap size information in the heap body area corresponds to a heap offset (heap_offset) value defined in 16-byte increments.

18. The apparatus of claim 16, wherein the heap size information corresponds to 1-bit information that indicates 1 when a size of the allocated heap area is greater than a preset size and that indicates 0 when the size of the allocated heap area is equal to or less than the preset size.

19. The apparatus of claim 13, wherein, when access to the heap area in the physical memory occurs, the physical memory management unit checks access permission information in the virtual memory corresponding to the physical memory and blocks the access based on the access permission information.

20. The apparatus of claim 19, wherein, when access to the heap area in the physical memory occurs, the virtual memory management unit calculates an address of a header area of the virtual memory using heap size information in the virtual memory, and when heap size information at the calculated address corresponds to ‘0000000’, the virtual memory management unit determines that the address is not the header area of the virtual memory and again calculates the address of the header area of the virtual memory based on a multiple of ‘0x80’.
